(19) United States
(12) Patent Application Publication
(10) Pub. No.: US 2020/0087551 A1
(43) Pub. Date: Mar. 19, 2020

(54) METHODS FOR USING TWO SEAMING AGENTS ON ONE SYSTEM

(71) Applicant: Polysack Flexible Packaging Ltd., D.N. Negev (IL)

(72) Inventors: Izhar Halahmi, Hod Hasharon (IL); Nitai Alush-aben, Beit Yitzhak (IL)

(73) Assignee: Polysack Flexible Packaging Ltd.

(21) Appl. No.: 16/569,706

(22) Filed: Sep. 13, 2019

Related U.S. Application Data
(60) Provisional application No. 62/731,759, filed on Sep. 14, 2018.

(51) Int. Cl. C09J 133/14; C09J 135/02; B32B 38/00; B32B 37/12; B65C 9/00; B65C 9/26

(52) U.S. Cl. CPC C09J 133/14; C09J 135/02; B32B 38/0008; B65C 2009/0071; B65C 9/0015; B65C 9/26; B32B 2519/00; B32B 37/1284

(57) ABSTRACT

Broadly described herein are methods for using the same pumping and metering system to apply two different seaming agents consecutively without cleaning the system between the two seaming agents. This is useful when it is desired to produce high shrink wrap labels and low-shrink labels on the same production line. The two seaming agents are soluble in each other at loadings (w/w) of 1:10 to 10:1. Two sets of seaming agents are also disclosed, (a) a polar low-shrink seaming agent and a polar high-shrink seaming agent; and (b) a non-polar low-shrink seaming agent and a non-polar high-shrink seaming agent.

### CROSS-REFERENCE TO RELATED APPLICATIONS

This application claims priority to U.S. Provisional Patent Application Ser. No. 62/731,759, filed on Sep. 14, 2018, which is incorporated by reference in its entirety.

### BACKGROUND

The present disclosure relates to methods for affixing both high-shrink labels and low-shrink labels to articles using a single machine and a single pump-and-meter system PMS. In particular, the seaming agents for both types of labels can be applied by a single pump-and-meter system (PMS) that applies different seaming agents with no need for cleaning the PMS or changing out parts. Various seaming agents (i.e. adhesive compositions) and systems for performing such methods are also disclosed. Further disclosed are containers or other articles comprising such heat-shrink labels.

It is common for labels to be affixed to articles, such as containers for food and beverages. Roll fed machines (RF) for this purpose are low cost and thus very popular among bottlers. Unfortunately, RF machines can only be used for non-shrink labels or low shrink labels (<20% shrinkage). As a result, if a bottler desires to both manufacture articles with low shrink labels and articles with high shrink labels, the bottler typically needs two separate machines, which fills the production floor.

In low shrink labels that have 0-20% shrinkage, a hot melt adhesive is usually used in the seam of the label to join the leading edge and trailing edge of the label together. In this range of shrinkage, the forces on the seam are not too high and hot melt adhesive can withstand them and are economical. A hot melt adhesive usually comprises high molecular weight polymers, is applied at high temperatures (usually in the range of 120° C. to 150° C.), and has high viscosity.

High shrink labels have greater than 25% shrinkage. In these cases, hot melt adhesives generally cannot withstand the shrinkage forces that arise during shrinkage of the label, especially when steam heating is used. Thus, solvent welding is typically used in forming the seam of a high shrink label.

Three conventional methods for forming high shrink wrap label sleeves are the RFS solvent method, the TD sleeve method, and the RF solvent method. In the RFS solvent method, the label is cut directly from a roll, and then wrapped around a smooth metal mandrel and simultaneously and immediately pressed by a roller against the mandrel to make a tight and even seam. The leading edge and the trailing edge of the label are welded together (using solvent) along a seam to form the sleeve. In the TD sleeve method, a long continuous tube is made from a film directly from a roll by solvent welding. The solvent dissolves the polymer of the label film, resulting in a swollen polymer. The two swollen edges are continuously and immediately pressed between rolls to create a mixed polymer network, providing a tight and even seam. The tube is then wound into a roll of sleeves. In the RF solvent method, a label is wrapped around a shaped article and the seam is solvent welded. Usually, THF solvent is used with a PETG label. This method is limited to speeds lower than 200 containers per minute, because solvent tends to splash out of the seam and damage the label at higher speeds.

The pump-and-meter systems (PMS) used for applying hot melt adhesive and for applying a seaming agent are different from each other, due to the differences in their viscosity, operating temperature, and other factors. Hot melt adhesives are difficult to clean with solvents, because the hot melt glue does not easily dissolve. A high viscosity hot melt adhesive cannot be dispensed using a PMS designed for low viscosity seaming agents, and vice versa. The need for two different PMS systems for making low-shrink labels and high-shrink labels increases capital costs, increases the floor space needed for production, and complicates the manufacturing process. This results in a high waste percentage, and the presence of hot melt equipment at temperatures greater than 100° C. create additional safety issues.

It would be desirable to provide methods that permit the production of both high shrink labels and low-shrink labels directly from a roll of film using a single machine that is already common, such as a RF labeling machine and a single PMS. Desirably, there is no need to clean or change parts in the PMS when changing from one type of label to the other. Additionally, it would be desirable if the maximum application temperature of the seaming agents is at most 60° C., due to safety concerns.

### BRIEF DESCRIPTION

Disclosed herein are methods for preparing high-shrink labels and low-shrink labels on a single machine and a single PMS. Briefly, the seaming agents for the high-shrink labels and the low-shrink labels are compatible with each other. The two seaming agents have the same polarity, and so can be dissolved into each other and form a clear solution that does not cause haze and does not harm the functionality of the seam. As a result, only a single pump-and-meter system (PMS) needs to be used to dispense the seaming agents. The single PMS does not need to be cleaned, or PMS parts do not have to be changed, when switching between production of the two label types. This reduces capital costs, reduces production complexity and space, as well as improves safety and reduces environmental impact. The label can be directly wrapped around the article and the edges of the label welded together to form a seam without the need to apply external pressure on the seam.

Disclosed herein in various embodiments are methods for applying a first label to a first article and a second label to a second article using a single pump-and-meter system. A leading edge of the first label is bonded to the first article. The single pump-and-meter system is then used to apply a first seaming agent to the leading edge or the trailing edge of the first label, the single pump-and-meter system being connected to a first seaming agent source. The first label is wrapped around the first article to form a seam that joins the trailing edge of the first label to the leading edge of the first label with the first seaming agent. The seam of the first label is then exposed to radiation.

The single pump-and-meter system is then disconnected from the first seaming agent source. The single pump-and-meter system is next connected to a second seaming agent source that contains a second seaming agent which is different from the first seaming agent.

A leading edge of the second label is then bonded to the second article. The single pump-and-meter system is used to apply the second seaming agent to the leading edge or the trailing edge of the second label. The second label is wrapped around the second article to form a seam that joins the trailing edge of the second label to the leading edge of the second label with the second seaming agent. The seam of the second label is then exposed to radiation. This results in two different labels being applied to two different articles.

The first seaming agent and the second seaming agent are soluble in each other at a ratio (w/w) of 1:10 to 10:1. When mixed together, the resulting solution is clear, free from haze and gel, and can still operate as a seaming agent. The two seaming agents are either both polar seaming agents, or are both non-polar seaming agents. The seam of the first label and the seam of the second label each have an immediate welding strength of at least 2 grams prior to exposing the seam to radiation. For test purposes, the immediate welding strength is measured with a seam area of 250 mm², though generally is the minimum desired welding strength regardless of the size of the seam area. The first seaming agent and the second seaming agent each have a viscosity of less than 1000 centipoise when measured at any temperature between ambient temperature and 60° C.

Generally, the pump-and-meter system is not flushed between disconnecting the first seaming agent source and connecting the single pump-and-meter system to the second seaming agent source.

Generally, the pump-and-meter system includes at least a pump, a nozzle, a port for a fluid source, and a fluid passageway between the nozzle and the port for the fluid source.

Generally, the first seaming agent and the second seaming agent each have at least one component that crosslinks or polymerizes upon exposure to radiation.

The seam may have an immediate welding strength (IWS) of at least 2 grams within a delta time period of about 0.5 seconds or less, preferably about 0.2 seconds or less, or even about 0.1 seconds or less, when measured on a seam area of 250 mm² of the associated film, as described further herein. Usually, seams having an IWS of about 4 grams or greater (so they do not open when loaded by 4 grams) tested on associated film at a delta time period of about 0.2 seconds or less (or about 0.1 seconds or less, and even about 0.06 seconds or less) will have a seam quality of at least 3, while those having between 2-4 grams IWS may have a seam quality of at least 2, and those having less than 2 grams IWS will open in a manner not acceptable in the commercial marketplace.

The radiation may be any radiation range that has at least one peak wavelength in the range of about 300 nm to about 500 nm. Such radiation can be broad band (e.g. mercury lamp) or narrow band (e.g. LED). The seams may be exposed to radiation at an average power density of at least 0.2 W/cm² as measured on the surface of the shaped article. The power density can be measured, for example, using a radiometer such as the LEDCure™ radiometer offered by EIT within any combination of the four response bands available (340-392 nm, 360-412 nm, 370-422 nm, or 380-432 nm). The seams may be exposed to radiation for a time period of about 0.05 seconds to about 5 seconds, preferably about 0.5 seconds to about 3 seconds. The combination of power density and exposure time should provide an exposure of about 0.5 W·sec/cm² to about 4 W·sec/cm².

One of the seaming agents is a low-shrink seaming agent useful for seaming low-shrink labels. The other seaming agent is a high-shrink seaming agent useful for seaming high-shrink labels. Two different sets of seaming agents are contemplated. The first set includes (1) a polar low-shrink seaming agent that is designed to seam low shrink films such as BOPP and BOPET and CPP; and (2) a polar high-shrink seaming agent that is designed to seam high shrink films such as PS, PVC, or PETG. The two polar seaming agents are compatible with each other, as discussed further herein. The second set includes (1) a non-polar low-shrink seaming agent that is designed to seam low shrink films such as BOPP and BOPET and CPP; and (2) a non-polar high-shrink seaming agent that is designed to seam high shrink films such as polyolefins like COC or COP. The two non-polar seaming agents are compatible with each other, as discussed further herein.

The polar low-shrink seaming agent (a) has a viscosity of about 300 centipoise to about 1000 centipoise when measured at any temperature between ambient and 60° C.; and (b) has an immediate welding strength of at least 2 grams that develops within 0.5 seconds when applied to BOPP, BOPET, or CPP; and (c) can obtain a seam quality of at least 2 when applied to biaxially oriented polypropylene (BOPP), biaxially oriented polyethylene terephthalate (BOPET), or cast polypropylene (CPP); and (d) is soluble in tetrahydrofurfuryl acrylate (THFA) at a ratio (w/w) of 1:10 to 10:1 (seaming agent to THFA).

The polar high-shrink seaming agent (a) has a Hildebrand solubility parameter that is within 2.2 MPa^{1/2} or within 4.4 calories^{1/2}·cm^{-3/2} of a Hildebrand solubility parameter of polyethylene terephthalate glycol-modified (PETG), polyvinyl chloride (PVC), or polystyrene (PS); and (b) has an immediate welding strength of at least 2 grams that develops within 0.5 seconds when applied to PS, PVC or PETG; and (c) has a viscosity from at least 1 centipoise to about 300 centipoise when measured at any temperature between ambient and 60° C.; and (d) can obtain a seam quality of at least 2 when applied to PETG, PVC, or PS; and (e) is soluble in tetrahydrofurfuryl acrylate (THFA) at a ratio (w/w) of 1:10 to 10:1 (seaming agent to THFA).

The non-polar low-shrink seaming agent (a) has a viscosity of about 300 centipoise to about 1000 centipoise when measured at any temperature between ambient and 60° C.; and (b) has an immediate welding strength of at least 2 grams that develops within 0.5 seconds when applied to BOPP, BOPET, or CPP; and (c) can obtain a seam quality of at least 2 when applied to biaxially oriented polypropylene (BOPP), biaxially oriented polyethylene terephthalate (BOPET), or cast polypropylene (CPP); and (d) is soluble in isobornyl acrylate (IBOA) at a ratio (w/w) of 1:10 to 10:1 (seaming agent to IBOA).

The non-polar high-shrink seaming agent (a) has a Hildebrand solubility parameter that is within 2.2 MPa^{1/2} or within 4.4 calories^{1/2}·cm^{-3/2} of a Hildebrand solubility parameter of a polyolefin like cyclic olefin polymer (COP) or a cyclic olefin copolymer (COC); and (b) has an immediate welding strength of at least 2 grams that develops within 0.5 seconds when applied to a polyolefin like COP or COC; and (c) has a viscosity from at least 1 centipoise to about 300 centipoise when measured at any temperature between ambient and 60° C.; and (d) can obtain a seam quality of at least 2 when applied to COP or COC; and (e) is soluble in isobornyl acrylate (IBOA) at a ratio (w/w) of 1:10 to 10:1 (seaming agent to IBOA).

A typical seam has a width of about 3 mm to about 10 mm. The seaming agents may be independently applied in an amount of about 0.2 milligrams (mg) to about 5 mg per square centimeter of seam area, including from about 0.3 mg to about 4 mg, or most preferably about 0.4 mg to about 2 mg per square centimeter of seam area. The seaming agents may be independently applied by spraying, drop-on-demand jetting, ink jetting, stamping, transfer from a rotating roller or rod, stamping, brushing, injecting from nozzle or needle, or ultrasonic spraying.

The labels can be made in any order. In the methods of the present disclosure, either (A) the first label is a low-shrink label and the second label is a high shrink wrap label; or (B) the first label is a high shrink wrap label and the second label is a low-shrink label.

The low-shrink label may comprise biaxially oriented polypropylene (BOPP), biaxially oriented polyethylene terephthalate (BOPET), cast polypropylene (CPP), and many others. The high shrink wrap label may be made of a film having at least one layer that comprises a cyclic olefin polymer (COP), a cyclic olefin copolymer (COC), polyethylene terephthalate glycol-modified (PETG), polyvinyl chloride (PVC), or polystyrene (PS).

The high-shrink seaming agents (polar or non-polar) used herein preferably have a viscosity of at least 1 centipoise (cP), including at least 5 cP, or about 10 centipoise (cP) to about 1000 cP, or from about 5 cP to about 300 cP, or from about 10 cP to about 450 cP, or from about 10 cP to about 250 cP when measured at ambient temperature or any temperature up to about 60° C. If the viscosity is greater than about 1000 cP, the seaming agent may have difficulty in completing the seaming action before the label is presented for radiation curing. If the viscosity is too low, the diffusion of monomer and/or solvent into the label film may proceed too quickly, and the label film may lose its transparency in the seam area or may rupture or may suffer holes. This is not acceptable in the commercial marketplace.

In some particular embodiments, the high-shrink seaming agent (polar or non-polar) may comprise: from about 20 wt % to about 99 wt % of an acrylic or methacrylic acid ester or amide or carbamate monomer having a molecular weight lower than 300 daltons (Da) and having good compatibility with the label film; 0 to about 75 wt % of an acrylic or methacrylic acid ester or amide or carbamate or any other oligomer or polymer having a molecular weight greater than 300 daltons (Da) and having good compatibility with the monomer; 0 to about 40 wt % of a tackifying agent or polymer having good compatibility with the monomer; 0 to about 50 wt % of an organic solvent; a photoinitiator; and optionally, an adhesion promoter.

The acrylic or methacrylic acid ester or amide or carbamate monomer with a molecular weight of less than 300 Da desirably has a Hildebrand solubility parameter that matches an external layer of the label film, i.e. is ±2.2 MPa^{1/2} of the Hildebrand solubility parameter of the external layer. This means the monomer is very likely to be able to swell and dissolve the high-shrink label film within a period of about 0.5 seconds or less, more desirably about 0.2 seconds or less, and even about 0.06 seconds or less, at a temperature of about 23° C. to about 60° C. to allow welding to obtain a seam with a seam quality of 2, 3, or 4.

The acrylic or methacrylic acid ester or amide or carbamate oligomer or other oligomer or polymer with a molecular weight of greater than 300 Da and having good compatibility with the monomer serves multiple purposes. This kind of compound can slow the diffusion of the lower-weight monomers (<300 Da) and/or the solvent, so the risk of film loss of clarity is minimized. Usually. higher molecular weight oligomers have higher functionality (more than one active group per molecule) and thus improved cross-link density, as well as curing speed. The improved cross-link density improves the ability of the cross linked seam to withstand shrink forces at elevated temperatures, including steam. This family of compounds increases the cross linking density, so that unwanted migration of monomer residues into the shaped article from cross linked seam is minimized. Finally, these higher-molecular weight oligomers improve the curing speed, allowing high production speeds with lower radiation power consumption.

The tackifying agent, a non-reactive oligomer, can also slow the diffusion of the lower-weight monomer (<300 Da) and/or the solvent, so the risk of film loss of clarity is minimized. The tackifying agent also improves the flexibility of the seam because it is not reactive and lowers cross-link density without increasing monomer or solvent content, and so functions as a solid plasticizer. This avoids cracking during high shrinkage. The tackifying agent also reduces the content of low molecular weight ingredients in the seaming agent, which are undesirable since they can more easily migrate from the label into the shaped article.

The organic solvent, like the monomer, has a Hildebrand solubility parameter that matches an external layer of the label film, i.e. is ±2.2 MPa^{1/2} of the Hildebrand solubility parameter of the external layer. This means the solvent is very likely to be able to swell and dissolve the high-shrink label film within a period of about 0.5 seconds or less, more desirably about 0.2 seconds or less, and even about 0.06 seconds or less, at a temperature of about 23° C. to about 60° C. to allow welding to obtain a seam with a seam quality of 2, 3, or 4. The organic solvent can improve penetration of the seaming agent ingredients into the external layer of the high-shrink label film, causing swelling and development of immediate welding strength if the low-molecular weight monomer is unable to do so within 0.5 seconds. The photoinitiator induces polymerization and cross-linking of the seaming agent upon exposure to radiation.

Specific compositions are contemplated for the seaming agent that is applied to the high shrink wrap label, depending on the material of which the high shrink wrap label is made. For example, the high shrink wrap label may comprise a polyolefin. Polyolefins typical to high shrink labels include cyclic olefin copolymers (COC) and cyclic olefin polymers (COP), including films having multiple layers of polyolefins, and/or a layer that is made of a blend of COC/COP with another polyolefin such as polyethylene, polypropylene, and copolymers thereof. These materials are non-polar.

In particular embodiments for polyolefin high shrink label films, the seaming agent may comprise (A) an acrylic or methacrylic acid ester or amide or carbamate containing a cyclic hydrocarbon group (such as isobornyl acrylate), (B) an acrylic or methacrylic acid ester or amide or carbamate containing a hydrocarbon group having a maximum of 20 carbon atoms (such as hexyl acrylate or ethyl hexyl acrylate, lauryl acrylate, stearyl acrylate, or 4-tert-butylcyclohexyl acrylate), or (C) an acrylic or methacrylic acid ester or amide or carbamate containing an aromatic hydrocarbon or heterocyclic group having a maximum of 20 carbon atoms (such asperillyl alcohol ester with acrylic or methacrylic acid). More desirably, the hydrocarbon or heterocyclic groups have a maximum of 15 carbon atoms. These molecules are monomers having a molecular weight of less than 300 Da and good compatibility with the label film, so as to be able to swell and dissolve the label film. Desirably, these monomers dissolve the label film within a period of about 0.5 seconds or less, or about 0.2 seconds or less, or about 0.1 seconds or less, or about 0.06 seconds or less.

In other embodiments, the shrink wrap label film may comprise at least one outer layer that comprises a cyclic olefin polymer (COP) or a cyclic olefin copolymer (COC) or a blend of COC or COP with another polyolefin. For such labels, the seaming agent may comprise a monomer selected from the group consisting of (A) isobornyl acrylate, (B) isobornyl methacrylate, (C) cyclohexyl acrylate, (D) ethyl hexyl acrylate, (E) ethyl hexyl methacrylate, (F) tert-butyl cyclohexyl acrylate, (G) trimethyl cyclohexyl acrylate, (H) alkyl acrylates, (I) alkyl methacrylates, (J) tricyclodecanedimethanol acrylate, (K) styrene, (L) vinyltoluene, (M) benzyl acrylate, (N) lauryl acrylate, (O) isodecyl acrylate, (P) phenoxy benzyl acrylate, (Q) ethoxylated aryl acrylate, (R) alkylated phenyl acrylate, and (S) phenyl acrylate. These monomers have a molecular weight lower than 300 daltons (Da) and good compatibility with the label film so as to be able to swell and dissolve the label film. Desirably, these monomers dissolve the label film within a period of about 0.5 seconds or less, or about 0.2 seconds or less, or about 0.1 seconds or less, or about 0.06 seconds or less.

Continuing, when the shrink wrap label comprises a cyclic olefin polymer (COP) or a cyclic olefin copolymer (COC), the seaming agent may additionally comprise an oligomer or polymer selected from the group consisting of (A) urethane acrylate, (B) urethane methacrylate, (C) acrylic or methacrylic esters of glycols or diols or polyhydric alcohols, (D) acrylic or methacrylic esters of alkoxylated diols or polyols or polyhydric alcohols, (E) oligomers of acrylic or methacrylic esters, (F) polyvinylbutyral, (G) hydrocarbon resins, (H) polyterpenes, (I) rosin derivatives, (J) polyesters, (K) polystyrene, (L) styrene homopolymers, copolymers, terpolymers and block co-polymers, (M) epoxy acrylates, (N) epoxy methacrylates, (O) phenoxy resins, (P) acrylated or methacrylated dendritic alcohols, (Q) ethoxylated diglycidyl ether of bisphenol A diacrylate; (R) polyacrylates of hyperbranched alcohols; (S) blends of urethane acrylate and monomer, such as Genomer 4188/EHA; and (T) blends of inert resin and monomer such as Genomer 6043/M22.

The non-polar high-shrink seaming agent may also comprise a solvent selected from the group consisting of a linear or cyclic or aromatic hydrocarbon having a maximum of 20 carbon atoms (such as limonene, pinene, hexane, heptane, cyclohexane, decane, pentane, alkyl cyclohexane, or decalin, xylene, or toluene); a terpene alcohol; an alkyl ester; an alkyl amide; turpentines; isoparaffins; and paraffins. These solvents have a molecular weight lower than 300 daltons (Da) and good compatibility with the label film. Desirably, these monomers dissolve the label film within a period of about 0.5 seconds or less, or about 0.2 seconds or less, or about 0.1 seconds or less, or about 0.06 seconds or less.

In other specific embodiments for COP or COC films, the seaming agent may comprise: from about 25 wt % to about 98 wt % of a monomer having a molecular weight lower than 300 daltons (Da) and having good compatibility with the label film; from 0 to about 50 wt % of an oligomer or polymer; 0 to about 50 wt % of an organic solvent having good compatibility with the label film; and from about 0.5 wt % to about 15 wt % of a photoinitiator. Seams made with seaming agents according to these specific embodiments will have a seam quality of 2, 3, or 4 (as defined further herein). Desirably, the monomers and/or solvents dissolve the label film within a period of about 0.5 seconds or less, or about 0.2 seconds or less, or about 0.1 seconds or less, or about 0.06 seconds or less.

In further specific embodiments for COP or COC films, when the shrink wrap label shrinks more than 25% and less than 75%, the seaming agent may comprise: from about 20 wt % to about 98 wt % of a monomer having a molecular weight lower than 300 daltons (Da) and having good compatibility with the label film; from 0 to about 45 wt % of an oligomer or polymer; from 0 wt % to about 30 wt % of an organic solvent having good compatibility with the label film; from about 1 wt % to about 15 wt % of a photoinitiator; and from 0 wt % to about 20 wt % of a tackifying agent. Seams made with seaming agents according to these specific embodiments will have a seam quality of 2, 3, or 4 (as defined further herein). Desirably, the monomers and/or solvents dissolve the label film within a period of about 0.5 seconds or less, or about 0.2 seconds or less, or about 0.1 seconds or less, or about 0.06 seconds or less.

In further specific embodiments for COP or COC films, when the shrink wrap label shrinks more than 25% and less than 50%, the seaming agent may comprise: from about 20 wt % to about 98 wt % of a monomer having a molecular weight lower than 300 daltons (Da) and having good compatibility with the label film; from 0 to about 45 wt % of an oligomer or polymer; from 0 wt % to about 25 wt % of an organic solvent having good compatibility with the label film; from about 1 wt % to about 15 wt % of a photoinitiator; and from 0 wt % to about 20 wt % of a tackifying agent. Seams made with seaming agents according to these specific embodiments will have a seam quality of 2, 3, or 4 (as defined further herein). Desirably, the monomers and/or solvents dissolve the label film within a period of about 0.5 seconds or less, or about 0.2 seconds or less, or about 0.1 seconds or less, or about 0.06 seconds or less.

In further specific embodiments for COP or COC films, when the shrink wrap label shrinks more than 25% and less than 40%, the seaming agent may comprise: from about 20 wt % to about 98 wt % of a monomer having a molecular weight lower than 300 daltons (Da) and having good compatibility with the label film; from 0 to about 45 wt % of an oligomer or polymer; from 0 wt % to about 15 wt % of an organic solvent having good compatibility with the label film; from about 1 wt % to about 15 wt % of a photoinitiator; and from 0 wt % to about 20 wt % of a tackifying agent. Seams made with seaming agents according to these specific embodiments will have a seam quality of 2, 3, or 4 (as defined further herein). Desirably, the monomers and/or solvents dissolve the label film within a period of about 0.5 seconds or less, or about 0.2 seconds or less, or about 0.1 seconds or less, or about 0.06 seconds or less.

In other embodiments, the high shrink wrap label may be a single-layer film or a multi-layer film having at least one external layer comprising PS, PETG, or PVC. PS is an abbreviation for a group of polymers that includes polystyrene, styrene copolymers and terpolymers, styrene block copolymers, and blends of polystyrene with other polymers. PETG is an abbreviation for polyethylene terephthalate glycol-modified, and PVC is an abbreviation for polyvinyl chloride. These materials are polar materials.

For such shrink wrap labels made of PS, PETG, or PVC, the seaming agent applied to the high shrink wrap label may comprise a monomer that is an acrylic or methacrylic ester, amide, or carbamate having (a) a cyclic ether containing group, such as tetrahydrofurfuryl or 5-ethyl-1,3-dioxane-5-methanol or dioxane; or (b) an alkoxylated (e.g. ethoxylated or propoxylated) aromatic or aliphatic or cycloaliphatic group, such as alkoxylated phenyl acrylate or ethoxylated trimethylol propane triacrylate. The seaming agent can alternatively, or additionally, comprise a monomer that is (c) a monoacrylate or diacrylate or triacrylate or polyacrylate or methacrylate of an alkyl diol or polyol, such as hexanediol diacrylate, butanediol diacrylate, or trimethylolpropane triacrylate; (d) a vinyl lactam; (e) an acrylamide or methacrylamide; (f) vinyl pyrrolidone or a similar nitrogen heterocyclic unsaturated monomer; (g) a vinyl morpholine; (h) a lactone or lactam having an acrylate, methacrylate, or vinyl group; (i) a phenyl or alkyl phenol acrylate or methacrylate; (j) an ethoxylated or propoxylated phenyl or alkyl phenol acrylate or methacrylate; (k) a mono- or di- or tri-hydroxyl acid acrylate or methacrylate; (l) an urethane acrylate or methacrylate; (m) an allyl ether; (n) a vinyl ester; (o) a mono-, di-, tri-, tetra-, or poly-acrylate or -methacrylate of a polyhydric alcohol, including an ethoxylated or propoxylated polyhydric alcohol; or (p) 2-(2-ethoxyethoxy)ethyl acrylate (EOEOEA). Examples of such monomers are: tetrahydrofurfuryl acrylate (THFA) or caprolactone-modified THFA, cyclic trimethylolpropane formal acrylate (CTFA), isobornyl acrylate, isobornyl methacrylate, alkoxylated phenol acrylate such as phenol (EO)4 acrylate or ethoxylated phenoxy ethyl acrylate, hexanediol diacrylate, butanediol diacrylate, butanediol dimethacrylates, alkoxylated aliphatic or cycloaliphatic diol diacrylate or dimethacrylate such as 1,6-Hexanediol (EO)ₙ Diacrylate, tricyclodecanedimethanol diacrylate (TCDDA), ethoxylated cyclohexane dimethanol diacrylate (EO-CHMDA), hydroxy pivalic acid neopentyl glycol diacrylate or caprolactone-modified hydroxy pivalic acid neopentyl glycol diacrylate, hydroxypyvalyl pivalate diacrylate (HPPDA), and caprolactone acrylate. These monomers have a molecular weight lower than 300 daltons (Da) and good compatibility with the label film so as to be able to swell and dissolve the label film within a period of about 0.5 seconds or less, or about 0.2 seconds or less, or about 0.1 seconds or less, or about 0.06 seconds or less.

Continuing, for shrink wrap labels comprising PS, PETG, or PVC, the seaming agent may comprise an oligomer or polymer selected from the group consisting of (A) urethane acrylate, (B) urethane methacrylate, (C) acrylic or methacrylic esters of glycols or diols or polyhydric alcohols (such as glycerol triacrylate, trimethylol propane triacrylate, dipentaerythritol hexaacrylate, caprolactone-modified dipentaerythritol hexaacrylate, pentaerythritol tetraacrylate, di(trimethylolpropane) tetraacrylate, dipentaerythritol pentaacrylate, polyacrylate of dendritic alcohol, or propoxylated glycerol triacrylate), (D) acrylic or methacrylic esters of alkoxylated diols or polyols or polyhydric alcohols, (E) oligomers of acrylic esters, (F) polyvinylbutyral, (G) hydrocarbon resins, (H) polyterpenes, (I) rosin derivatives, (J) polyesters, (K) epoxy resins; (L) epoxy acrylates, (M) epoxy methacrylates, (N) phenoxy resins, (O) a resin containing a diglycidyl ether of bisphenol-A, (P) polystyrene, (Q) styrene block copolymers or terpolymers, (R) terpene phenols, (S) polyester acrylates or methacrylates, (T) polyurethane, (U) polyesteramide, (V) oligomers of acrylic or methacrylic acids or esters or amides (including copolymers and terpolymers thereof), (W) homopolymers, copolymers, terpolymers, or block copolymers of an acrylic acid ester or methacrylic ester; (X) ethoxylated diglycidyl ether of bisphenol A diacrylate; (Y) polyacrylates of hyperbranched alcohols; (Z) blends of urethane acrylate and monomer, such as Genomer 4188/EHA; and (AA) blends of inert resin and monomer such as Genomer 6043/M22.

In additional embodiments, for shrink wrap labels containing PS, PETG, or PVC, the seaming agent may comprise a solvent selected from the group consisting of ethers, cyclic ethers, esters, amides, glycol ethers, ketones, aromatics, halogenated alcohols, and halogenated hydrocarbons. Examples of suitable solvents are tetrahydrofuran (THF), toluene, acetone, methyl ethyl ketone, diethyl ether, dioxane, halogenated ketones, ethyl acetate, hydroxyacetone, and acetonitrile. These solvents have a molecular weight lower than 300 daltons (Da) and good compatibility with the label film so as to be able to swell and dissolve the label film within a period of about 0.5 seconds or less, or about 0.2 seconds or less, or about 0.1 seconds or less, or about 0.06 seconds or less to obtain a seam with a seam quality of 2, 3, or 4.

In more particular embodiments, for high shrink wrap labels comprising PS, PETG, or PVC, the seaming agent may comprise: from about 25 wt % to about 98 wt % of a monomer having good compatibility with the label film; from 0 wt % to about 75 wt % of an oligomer or polymer; 0 to about 50 wt % of an organic solvent; and from about 0.5 wt % to about 15 wt % of a photoinitiator. Seams made with seaming agents according to these specific embodiments will have a seam quality of 2, 3, or 4 (as defined further herein). Desirably, the monomers and/or solvents dissolve the label film within a period of about 0.5 seconds or less, or about 0.2 seconds or less, or about 0.1 seconds or less, or about 0.06 seconds or less.

For high shrink wrap labels comprising PS, PETG, or PVC, where the high shrink wrap label shrinks more than 25% and less than 50%, the seaming agent may comprise: from about 15 wt % to about 90 wt % of a monomer having good compatibility with the label film; 0 to about 75 wt % of an oligomer or polymer; 0 to about 20 wt % of an organic solvent; from about 0.5 wt % to about 15 wt % of a photoinitiator; and 0 to about 20 wt % of a tackifying agent. Seams made with seaming agents according to these specific embodiments will have a seam quality of 2, 3, or 4 (as defined further herein). Desirably, the monomers and/or solvents dissolve the label film within a period of about 0.5 seconds or less, or about 0.2 seconds or less, or about 0.1 seconds or less, or about 0.06 seconds or less.

For high shrink wrap labels made of PS, PETG, or PVC, where the high shrink wrap label high shrinks more than 25% and less than 40%, the seaming agent may comprise: from about 10 wt % to about 90 wt % of a monomer having good compatibility with the label film; 0 to about 80 wt % of an oligomer or polymer; 0 to about 10 wt % of an organic solvent; from about 0.5 wt % to about 15 wt % of a photoinitiator; and 0 to about 20 wt % of a tackifying agent. Seams made with seaming agents according to these specific embodiments will have a seam quality of 2, 3, or 4 (as defined further herein). Desirably, the monomers and/or solvents dissolve the label film within a period of about 0.5 seconds or less, or about 0.2 seconds or less, or about 0.1 seconds or less, or about 0.06 seconds or less.

It is particularly contemplated that the seaming agents of the present disclosure result in highly reduced VOC emissions. The polymerized seam may emit a % VOC of less than 25 wt %, or less than 20 wt %, or less than 15 wt %, or less than 10 wt %, or less than 5 wt %, or less than 2%, after exposure to radiation and curing, when measured according to the modified method described in Example 4 herein.

Also disclosed here are sets of two different polar seaming agents, comprising a polar low-shrink seaming agent and a polar high-shrink seaming agent. The polar low-shrink seaming agent (a) has a viscosity of about 300 centipoise to about 1000 centipoise when measured at any temperature between ambient and 60° C.; and (b) has an immediate welding strength of at least 2 grams that develops within 0.5 seconds when applied to biaxially oriented polypropylene (BOPP), biaxially oriented polyethylene terephthalate (BOPET), or cast polypropylene (CPP); and (c) can obtain a seam quality of at least 2 when applied to BOPP, BOPET, or CPP. The polar high-shrink seaming agent (a) has a Hildebrand solubility parameter that is within 2.2 MPa^{1/2} or within 4.4 calories^{1/2}·cm^{-3/2} of a Hildebrand solubility parameter of polyethylene terephthalate glycol-modified (PETG), polyvinyl chloride (PVC), or polystyrene (PS); and (b) has an immediate welding strength of at least 2 grams that develops within 0.5 seconds when applied to PETG, PVC, or PS; and (c) has a viscosity from at least 1 centipoise to about 300 centipoise when measured at any temperature between ambient and 60° C.; and (d) can obtain a seam quality of at least 2 when applied to PETG, PVC, or PS. The polar low-shrink seaming agent and the polar high-shrink seaming agent are compatible with each other, and can both be cured within 5 seconds.

Also disclosed herein are sets of two different non-polar seaming agents, comprising a non-polar low-shrink seaming agent and a non-polar high-shrink seaming agent. The non-polar low-shrink seaming agent (a) has a viscosity of about 300 centipoise to about 1000 centipoise when measured at any temperature between ambient and 60° C.; and (b) has an immediate welding strength of at least 2 grams that develops within 0.5 seconds when applied to biaxially oriented polypropylene (BOPP), biaxially oriented polyethylene terephthalate (BOPET), or cast polypropylene (CPP); and (c) can obtain a seam quality of at least 2 when applied to BOPP, BOPET, or CPP. The non-polar high-shrink seaming agent (a) has a Hildebrand solubility parameter that is within 2.2 MPa^{1/2} or within 4.4 calories^{1/2}·cm^{-3/2} of a Hildebrand solubility parameter of a polyolefin or a cyclic olefin polymer (COP) or a cyclic olefin copolymer (COC); and (b) has an immediate welding strength of at least 2 grams that develops within 0.5 seconds when applied to a polyolefin or COP or COC; and (c) has a viscosity from at least 1 centipoise to about 300 centipoise when measured at any temperature between ambient and 60° C.; and (d) can obtain a seam quality of at least 2 when applied to a polyolefin or COP or COC. The non-polar low-shrink seaming agent and the non-polar high-shrink seaming agent are compatible with each other, and can both be cured within 5 seconds.

These and other non-limiting characteristics of the disclosure are more particularly disclosed below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 is a diagram illustrating a first method of the present disclosure, where labels are applied directly to articles.

FIG. 2 is a diagram of a label, with various parts of the label identified for reference.

FIG. 3 is a schematic diagram of a pump-and-meter system.

FIG. 4 is a first picture illustrating the test for measuring the immediate welding strength. A first strip of 25 mm width, made of a high shrink label, is used to simulate the leading edge of the label. The first strip is attached to a vacuum drum, and clamped by the right clamp. The right clamp remains “clamped” during the entire test.

FIG. 5 shows the first strip wrapped onto the vacuum drum and the right clamp pressed down to keep the first strip from moving.

FIG. 6 is a third picture of the immediate welding strength test, showing a second strip (made of the same material as the first strip) having the same width as the first strip (and used to simulate the trailing edge of the label) being held by the left piston of the test device. An upper edge of the second strip is located at a ramp, simulating the ramp on drum that allows the leading and trailing edges to contact each other. Seaming agent is applied to this upper edge by a 6 mm wide brush, dispensing about 1 to about 2 mg of seaming agent on the area on top of ramp R. This amount is equal to about 0.4 to about 0.8 mg per square centimeter of seam area (because the 6 mm wide brush line of seaming agent flows, wetting a total width of 10 mm). The lower edge of the second strip hangs over the edge of the test device. The lower edge passes through a low friction sliding roller, and a load is applied at the lower edge. Different loads are used, and the maximal load that the seam can carry without failure is the “immediate welding strength”. The left piston secures the left strip from falling due to the load. When the system is activated by an electrical trigger, the vacuum drum travels toward the ramp, so the first strip (leading edge) contacts the seaming agent on the second strip on the ramp. The seaming agent flows via capillary action to create an overlapping seam with a width of 10 mm (so the surface area of seam is 25 mm×10 mm). The right piston remains closed, while the left piston opens and releases the left strip, within a pre-defined delta time after the first strip is welded to the second strip by the seaming agent. This delta time simulates the time on the wrap around machine that the seam is held by the vacuum drum before being released to a conveyor, where the seam must withstand accelerations on the conveyor when approaching the radiation-curing tunnel. The typical delta time period on a wrap-around machine varies between about 40 milliseconds (ms) for extremely fast production lines and about 500 ms for slow production lines.

FIG. 7 is a fourth picture of the welding strength test. It shows a seam on testing machine after releasing of left piston. Here, the seaming agent was strong enough to hold against the applied load. The data generated by the immediate welding strength test includes: film composition, seaming agent composition, load, delta time period, and pass or fail.

### DETAILED DESCRIPTION

A more complete understanding of the compositions and methods disclosed herein can be obtained by reference to the accompanying drawings. These figures are merely schematic representations based on convenience and the ease of demonstrating the present disclosure, and are, therefore, not intended to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

### Definitions

The present disclosure refers to a “pump-and-meter system” or “PMS”. This term refers to a device or system that is designed to: (A) pump a seaming agent at a controlled temperature, usually between 20° C. and 200° C.; (B) meter out an accurate amount of the seaming agent; and (C) transfer the metered amount of the seaming agent to a surface at a pre-defined frequency. The frequency can be measured in shots per unit time, volume or weight per unit time, or dots per unit time.

A “Dedicated Surface” is a surface designed to receive seaming agent from a PMS. Examples of Dedicated Surfaces include the label itself; a liquid transferring platform such as a roller, stamp, brush, ramp, engraved surface, sponge, nozzle or plurality of nozzles, or a cloth.

The present disclosure relates to combinations of two seaming agents which are compatible with each other. Two seaming agents are “compatible” with each other if the first seaming agent can be dissolved in the second seaming agent in a ratio (w/w) of 10:1 to 1:10 and the resulting solution is clear and has no haze, and the solution can still function as a seaming agent, and vice versa.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims should be understood to include numerical values which are the same when reduced to the same number of significant figures and numerical values which differ from the stated value by less than the experimental error of conventional measurement technique of the type described in the present application to determine the value. When used in relation to polymers, such numerical values should be considered to reflect average values for the polymer, which reflect the fact that individual polymeric molecules can have different characteristics.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, approximating language such as “about” may be applied to modify any quantitative representation that may vary without resulting in a change in the basic function to which it is related. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The present disclosure may refer to temperatures for certain process steps. It is noted that these generally refer to the temperature at which the heat source (e.g. furnace) is set, and do not necessarily refer to the temperature which must be attained by the material being exposed to the heat.

The term “ambient temperature” refers to a temperature of 20° C. to 25° C.

The term “low shrink label” refers to a label that is intended to be applied to an article and then shrunk by less than 20% in the machine direction. It is noted that no-shrink labels should be considered a subset of low shrink labels. Examples of low-shrink films include BOPP, BOPET, and CPP, as discussed further herein.

The term “high shrink label” refers to a label that is intended to be applied to an article and then shrunk by at least 25% and up to 75% in the machine direction. Examples of high-shrink films include COP, COC, PETG, PVC, and PS, as discussed further herein.

The seam of a high shrink wrap label applied to a shaped article may have “supported” areas and “unsupported” areas. A “supported” area of the seam is in full contact with the body of the article. Application of external pressure to a supported area of a seam will form a tight and even seam. An “unsupported” area of the seam does not contact the body of the article. Application of external pressure to an unsupported area of a seam does not assist in seam formation according to the present disclosure.

A “shaped” article is an article that has unsupported areas amounting to at least 10% of the height of the article.

The quality of a seam can be described numerically on a scale of 1-4, with 1 being the lowest quality and 4 being the highest quality. A seam quality of 1 indicates the seam has an open seam area with a length greater than 1 inch. A seam quality of 2 indicates the seam does not have any open seam areas with a length greater than 1 inch. A seam quality of 3 indicates the seam does not have any open seam areas with a length greater than 0.5 inches. A seam quality of 4 indicates the seam does not have any open seam areas with a length greater than 0.25 inches. A seam is given the highest quality possible. In other words, a seam that has a seam quality of 4 also meets the requirements for a seam quality of 3 and 2. The phrase “a seam quality of at least X” means the seam quality is X or higher. For example, a seam quality of “at least 2” means the seam can have a seam quality of 2, 3, or 4.

A “cured” seam has been polymerized and crosslinked by exposure to radiation.

The present disclosure refers to the “immediate welding strength” (IWS). This is the cohesion force developed between two film edges (of an associated film) within a defined period of time. The IWS is measured according to the method described in Example 2.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “acrylic” or “acrylate” refers to a radical of the formula R₁R₂C═C—CO—OR₃, where R₁, R₂, and R₃ are independently hydrogen, alkyl, or aryl, heterocyclic, cycloaliphatic, ether, silicone, hydroxyl, polyhydric alcohol, hydrocarbon, or to a molecule containing such a radical. The term “methacrylic” refers to an acrylic radical or molecule where R₂ is methyl.

The term “ether” refers to a radical in which an oxygen atom is covalently bonded to two other carbon atoms (i.e. R—O—R′), or to a molecule containing such a radical.

The term “silicone” refers to a radical of the formula—[(SiO)R₁R₂]ₙ, where R₁ and R₂ are independently hydrogen and alkyl, and n indicates the number of repeating units.

The term “ester” refers to a radical of the formula —CO—O—, wherein the carbon atom and the oxygen atom are both covalently bonded to carbon atoms, or a molecule containing such a radical.

The term “amide” refers to a radical of the formula —CO—NH—, wherein the nitrogen atom and the carbon atom are both covalently bonded to carbon atoms, or to a molecule containing such a radical.

The term “carbamate” refers to a radical of the formula —NH—CO—O—, wherein the nitrogen atom and the oxygen atom are both covalently bonded to carbon atoms, or to a molecule containing such a radical.

The term “polyolefin” refers to a polymer that is prepared by the polymerization of an olefin. Examples of polyolefins include polyethylene and polypropylene. Polyolefins can also be formed from cyclic olefins, including copolymers with ethylene or propylene. It is noted that polyolefins are also hydrocarbons.

The term “derivative” refers to a molecule that contains the named substituent. For example, an “isobornyl derivative” is a molecule that contains an isobornyl group.

The term “aliphatic” refers to a linear or branched or cyclic array of atoms that is not aromatic and is composed exclusively of carbon and hydrogen. The aliphatic group may be substituted or unsubstituted, and any substitutions can be of a carbon atom or a hydrogen atom. Exemplary aliphatic groups include, but are not limited to, methyl, ethyl, isopropyl, hexyl, and cyclohexyl. Alkanes, alkenes, and alkynes are types of aliphatic compounds.

The term “hydrocarbon” refers to a radical which is composed exclusively of carbon and hydrogen, or to such a molecule. Alkyl, cyclic olefin, and aryl groups are considered hydrocarbon groups.

The term “cyclic” refers to a radical having a ring structure, or to a molecule having a ring structure. This term does not require the ring to be aromatic.

The term “heterocyclic” refers to a radical having a ring structure that contains at least one heteroatom, such as nitrogen, sulfur, or oxygen. This term does not require the ring to be aromatic.

The term “aromatic” refers to a radical or molecule having a ring system containing a delocalized conjugated pi system with a number of pi-electrons that obeys Hückel's Rule. The ring system may include heteroatoms such as nitrogen, sulfur, selenium, silicon and oxygen, or may be composed exclusively of carbon and hydrogen. Aromatic groups are not substituted. Exemplary aromatic groups include, but are not limited to, phenyl, pyridyl, furanyl, thienyl, naphthyl and biphenyl.

The term “copolymer” refers to a polymeric molecule derived from two or more structural unit or monomeric species, as opposed to a homopolymer, which is a molecule derived from only one structural unit or monomer. The term “dipolymer” refers to a molecule derived specifically from only two different monomers. The term “terpolymer” refers to a molecule derived specifically from only three different monomers.

The term “urethane” refers to an oligomer or polymer whose monomers are joined together by carbamate linkages.

The term “glycol” refers to a radical that has two hydroxyl groups attached to different carbon atoms, and is a subset of diols, polyols, and polyhydric alcohols.

The term “polyhydric alcohol” refers to an alkane or alkene (linear or cyclic) which contains more than one hydroxyl group. The term “diol” refers to a radical that has two hydroxyl groups. Diols are a subset of polyhydric alcohols.

The term “rosin” refers to a highly viscous substance of plant or synthetic origin, from which volatile terpenes have been removed.

The term “epoxy” refers to a radical which is a cyclic ether (e.g. glycidyl group, oxirane group) with a three-atom ring, or to a molecule containing such a radical.

The term “ketone” refers to a carbonyl radical (—CO—) that is covalently bonded to two other carbon atoms (i.e. R—CO—R′), or to a molecule containing such a radical. The two other carbon atoms can be in an aliphatic group or in an aromatic group. An ester, amide, carbamate and a carboxylic acid are not considered to be a ketone, because their carbonyl carbon atom is bonded to only one carbon atom, as well as to a non-carbon atom.

The term “alkoxy” refers to an alkyl radical which is attached to an oxygen atom, i.e. —O—CₙH₂ₙ₊₁, to a molecule containing such a radical.

The term “hydroxyl” refers to a radical of the formula —OH, wherein the oxygen atom is covalently bonded to a carbon atom

The terms “carboxy” or “carboxyl” refers to a radical of the formula —COOH, wherein the carbon atom is covalently bonded to another carbon atom. It should be noted that for the purposes of this disclosure, a carboxyl group may be considered as having a hydroxyl group. However, it should be noted that a carboxyl group can participate in certain reactions differently from a hydroxyl group.

The term “alkyl” refers to a radical composed entirely of carbon atoms and hydrogen atoms which is fully saturated. The alkyl radical may be linear, branched, or cyclic.

The term “aryl” refers to an aromatic radical that is composed exclusively of carbon and hydrogen. Exemplary aryl groups include phenyl, naphthyl, and biphenyl. Note that “aryl” is a subset of aromatic.

The term “heteroaryl” refers to an aromatic radical having a ring system that is composed of carbon, hydrogen, and at least one heteroatom. Exemplary heteroaryl groups include pyridyl, furanyl, and thienyl. Note that “heteroaryl” is a subset of aromatic, and is exclusive of “aryl”.

The term “halogen” refers to fluorine, chlorine, bromine, and iodine. The prefix “halo” or the term “halogenated” indicates the substituent or molecule has been substituted with a halogen atom.

The term “crosslink” and its variants refer to the formation of a stable bond between two polymers/oligomers. This term is intended to encompass the formation of stable bonds that result in network formation, or the formation of stable bonds that result in chain extension. The term “cross-linkable” refers to the ability of a polymer/oligomer to form such stable bonds.

The present disclosure refers to “polymers,” “oligomers”, and “compounds”. A polymer is a large molecule composed of multiple repeating units chained together, the repeating units being derived from at least one monomer. One characteristic of a polymer is that different molecules of a polymer will have different lengths, and a polymer is described as having a molecular weight that is based on the average value of the chains (e.g. weight average or number average molecular weight). The art also distinguishes between an “oligomer” and a “polymer”, with an oligomer having only a few repeating units, while a polymer has many repeating units. For purposes of this disclosure, the term “oligomer” refers to such molecules having a weight average molecular weight of less than 5,000 Daltons, and the term “polymer” refers to molecules having a weight average molecular weight of 5,000 Daltons or more, as measured by GPC using polycarbonate molecular weight standards. In contrast, for a compound, all molecules will have the same molecular weight. Compared to a polymer, a compound is a small molecule. These molecular weights are measured prior to any radiation exposure.

The terms “PS” and “polystyrene” are used herein to refer to any polymer that includes a styrene monomer. This can include polystyrene homopolymers, styrene copolymers and terpolymers, styrene block copolymers, and blends of polystyrene with other polymers. These polymers may be referred to individually by their full name.

The phrase “up to” is used herein to refer to amounts of a particular ingredient or component. This phrase should be construed to set an upper limit of the recited value, and to require that the particular ingredient or component is present (i.e. in an amount greater than zero). If an ingredient is not required, the term “optional” will be used herein to indicate that the amount of that optional ingredient can be zero, or the amount will be expressly disclosed to include zero. Any description of an ingredient or component being optional should be construed to also disclose embodiments where the ingredient or component is present in an amount greater than zero.

Methods

The seam of a label is the area where the leading edge and the trailing edge of the label overlap each other and are welded together. Desirably, the seam has a seam quality of 2, 3, or 4 (as previously defined).

Welding is a process where the polymer chains from the leading and trailing edges of the label film diffuse to form a mixed polymer network at the interface with the seaming agent. The polymer chains are either melted or dissolved by a low molecular weight agent in the seaming agent, such as solvent. Only welding is able to provide a durable seam capable of withstanding heat shrink forces, especially during steam heating where both humidity and heat will stress the seam.

As previously discussed, low-shrink labels and high-shrink labels typically use different adhesives to form the seam of the label. Low-shrink labels use hot melt adhesives, whereas high-shrink labels use welding agents that are based on solvents. These different types of adhesives are not compatible with each other, and require different pump-and-meter systems (PMS) due to their different viscosities, molecular weight of ingredients, tendency to crystallize in hot melts, operating temperatures, and other factors. It would be desirable to provide methods for making both low-shrink labels and high-shrink labels on a single PMS, without requiring multiple PMS and without the need to flush and/or replace parts of the single PMS when changing from low-shrink to high-shrink, or vice versa. In the present disclosure, two different seaming agents are used to produce both low-shrink labels and high-shrink labels. The two different seaming agents are compatible with each other, i.e. can dissolve in each other or form a solution with each other within broad loading ranges and remain clear and free from gels, as well as retain their functionality. As a result, there is no need to clean the single PMS, whether by using cleaning solvents or by switching out PMS parts, when switching between the two seaming agents.

For high shrink labels, it is important to understand the difference between conventional radiation cured adhesives and the radiation cured seaming agents of the present disclosure. Prior art glues adhere to the surface of a film by tack forces, usually by adding very large molecules that can tack the surface but not swell and migrate into the film matrix. Due to that, the interface between the label film surface and the glue itself is relatively weak—regardless of how strong the cross-linked glue is internally. The outcome of this is a failure (between adhesive and film) at shrinkages greater than 25%. The seaming agents of the present disclosure operate in a completely different manner. First, low molecular weight monomers, selected carefully to have a similar Hildebrand solubility parameter to an external layer of the label film, diffuse very quickly into the polymeric matrix of the film. Due to their low molecular weight, this process takes place within a period of about 0.5 seconds or less, including about 0.2 seconds or less, and may even be about 0.06 seconds or less. Another aspect of the present disclosure is the option to combine monomers and solvents, both carefully selected to match the Hildebrand solubility parameter of the high-shrink label film. The solvent allows for an improved penetration rate, as well as the ability to closely match the Hildebrand solubility parameter of the label film. The result is establishment of an inter-penetrating network of film molecules and seaming agent molecules in the interface of the film and the seaming agent, so that they unite into one mass.

This occurs without the drawbacks of solvent bonding. Here, the relatively high molecular weight oligomers, polymers, and tackifiers in the seaming agent function as diffusion suppressants, balancing the aggressive attack of solvents and/or monomers on the label film. In addition, lower molecular weight solvents are highly flammable. Surprisingly, when the solvent content in the seaming agent is 50% or less (including 30% or less, more desirably 20% or less, and most desirably 5% or less), the flash point of the seaming agent is more affected by the presence of the monomers and oligomers, and found to be greater than 80° C., and typically even greater than 100 Celsius. Surprisingly, the cross linked seaming agent of the present disclosure has % VOC emissions varying from zero (when no solvent, only monomers and optionally oligomers or polymers are present), through less than 7% VOC emission when the solvent content is up to 15 wt % of the seaming agent, less than 13% VOC emission when the solvent content is up to 24 wt % of the seaming agent, and less than 20% VOC emission when the solvent content is up to 30 wt % of the seaming agent (all % VOC data generated according to a modified ASTM D5403-93, as described in Example 4). Without being limited by theory, it appears the solvent molecules are “caged” in a cross-linked polymeric matrix, said matrix being composed of a blend of polymerized seaming agent ingredient and film polymer molecules present in the seam and formed during the welding phase.

The seaming agents can be used at any application temperature between ambient temperature and about 60° C. This range balances safety and ease of operation. In contrast, hot melt adhesives are normally applied at temperatures greater than 60° C., sometimes even greater than 100° C. Due to these high temperatures, hot melt adhesives, when applied to high shrink wrap labels, tend to initiate premature shrinkage near the seam. Such high temperatures also create safety issues for machine operators.

In order to allow high production rates (i.e. immediate welding within about 0.5 seconds, more preferably within about 0.2 seconds, and for high speed lines within about 0.06 seconds), the seaming agents of the present disclosure have a viscosity of at least 1 centipoise (cPs) and about 1000 cPs or less at application temperature. Desirably, the viscosity is about 300 cPs or less, or about 200 cPs or less. In particular embodiments, seaming agents with a viscosity of about 100 cPs or less are particularly useful for highly curved articles, which may have unsupported areas that are greater than 25% of the article height, or even greater than 40% of the article height. The minimum viscosity for the seaming agent is 1 cPs.

Once a seam has been established and the article has been successfully wrapped with the high shrink wrap label, the seam desirably has a seam quality of 2, 3, or 4. The seam has sufficient resistance to shrink forces and especially to shrink forces combined with steam. The polymerization and cross-linking that form the seam desirably occur within less than 5 seconds, or less than 2 seconds, or less than 1 second.

The polymerization and cross-linking occur by exposing the seam to radiation. This radiation may be provided by any number of bulbs or light-emitting diodes (LEDs), including combinations thereof. The radiation may have at least one peak wavelength of about 300 nm to about 500 nm. The seam may be exposed to radiation at an average power density of at least 0.2 W/cm², preferably at least 0.5 W/cm², even more preferably at least 1 W/cm² as measured on the surface of the shaped article.

In the present disclosure, two different seaming agents are used. A first seaming agent is used with a first label, and a second seaming agent is used with a second label. The first label and the second label are different from each other. One of the labels is a low-shrink label made of appropriate materials, and the other label is a high-shrink label made of appropriate materials. Generally, the low-shrink label can be applied to a shaped article or a non-shaped article (depending on whether it is a non-shrink label or simply shrinks a small amount), and the high-shrink label will be applied to a shaped article.

For both label types, the label is cut directly from a roll of film. The label film can be a single-layer film or a multi-layer film. In the high-shrink multi-layer film, the external layer is desirably compatible with the high-shrink seaming agent. The high-shrink single-layer film can be considered an external layer as well. Low-shrink labels can be made from biaxially oriented polypropylene (BOPP) biaxially oriented polyethylene terephthalate (BOPET), cast polypropylene (CPP), and many others. High-shrink labels can be made from many different materials. These materials include polyolefins such as a cyclic olefin polymer (COP) or a cyclic olefin copolymer (COC); the PS group previously defined; polyethylene terephthalate glycol-modified (PETG); and polyvinyl chloride (PVC); and blends containing one of these polymers. Very generally, the low-shrink film materials are more crystalline than the high-shrink film materials, which are more amorphous. Some of the high-shrink materials, particularly polyolefins such as COP and COC, are non-polar materials. In contrast, PETG, PVC, and PS are polar-materials.

The label is applied directly to an article. In this regard, the low-shrink labels can be produced first using the single pump-and-meter system (PMS) and the high-shrink labels can be produced second, or vice versa.

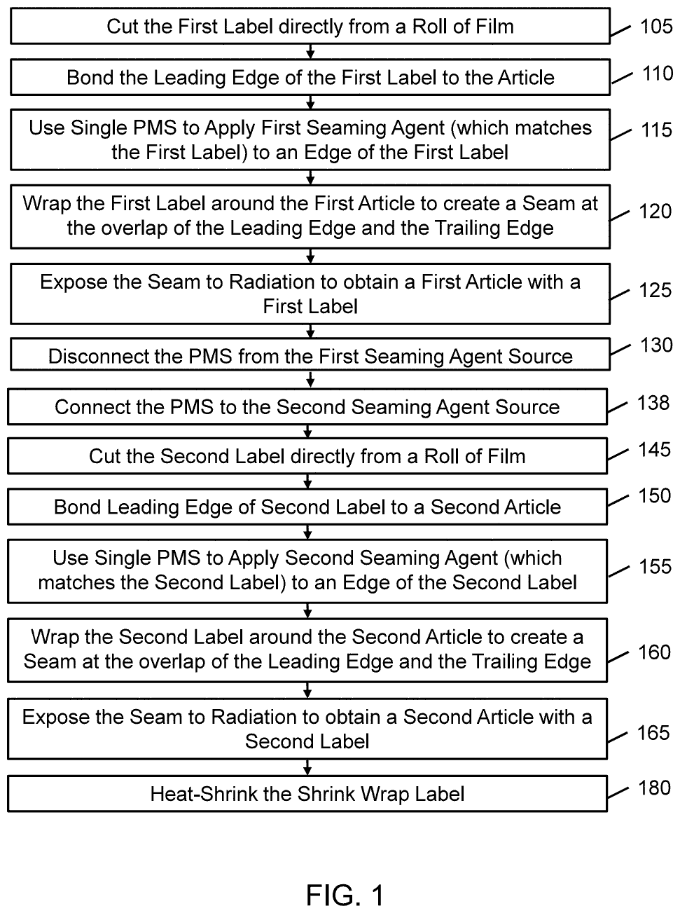

FIG. 1 illustrates one example of the methods of the present disclosure, where the two different types of labels are directly applied to articles, such as a container. It is noted that any discussion of the first label and first seaming agent also apply to the second label and second seaming agent, except as noted.

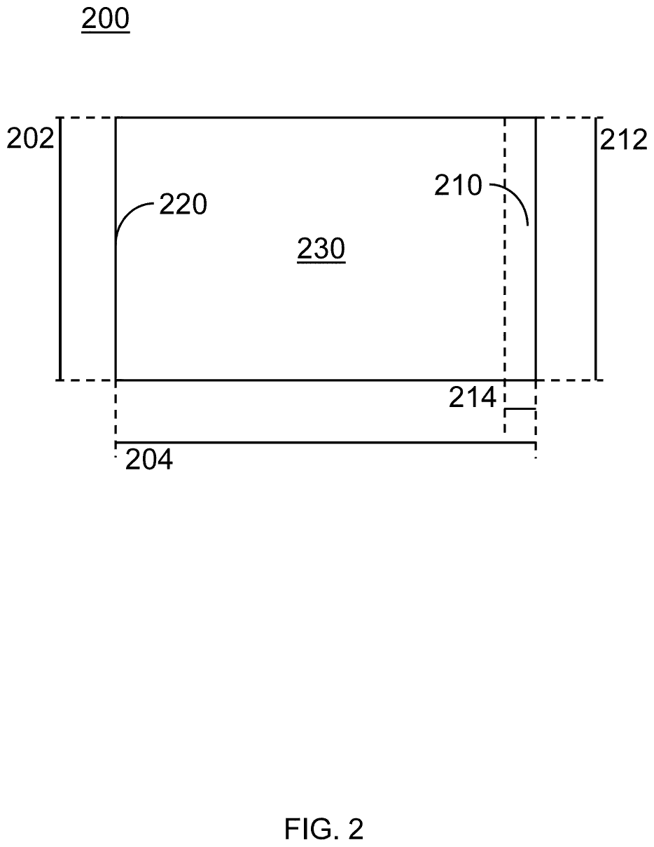

In step 105, the first label is cut directly from a roll of film. Generally speaking, the first label is a flat film in the shape of a rectangle, having a leading edge and a trailing edge (defined by how the label is applied to the container). The first label has a height and a length. Referring to FIG. 2, the first label 200 has a leading edge 210 and a trailing edge 220. The leading edge 210 of the first label 200 has a height 212, which is measured in the same direction as the height 202 of the overall label, and has a width 214 which is measured in the same direction as the length 204 of the label. The width of the overlap of the trailing edge and the leading edge, which will become the seam, may range from about 3 mm to about 10 mm. The first label may also be considered to have an interior surface 230 and an exterior surface (not visible). The interior surface is the surface adjacent to the shaped container, and the exterior surface is the exposed surface that is visible to the consumer. Again, the first label can be made from a single-layer film, or can be made from a multi-layer film having two external layers.

Referring back to FIG. 1, in step 110, the leading edge of the first label is bonded to a first article. The leading edge of the first label may be bonded to the first article using a hot melt adhesive, a pressure-sensitive adhesive, or a radiation-curable adhesive. An adhesive is applied to either (a) the interior surface of the label; or (b) the exterior surface of the container, to bond the leading edge of the first label to the first article.

In step 115, the single pump-and-meter system (PMS) is used to apply a first seaming agent to the leading edge of the first label or the trailing edge of the first label. More specifically, the first seaming agent is applied to the leading edge on the exterior surface of the first label, or is applied to the trailing edge on the interior surface of the first label. The width of the seam may range from about 3 millimeters (mm) to about 10 mm. The first seaming agent is described further herein. The first seaming agent may be applied in an amount of about 0.2 milligrams (mg) to about 5 mg per square centimeter of seam area. The first seaming agent may be applied by spraying, drop-on-demand jetting, ink jetting, stamping, transfer from a rotating roller, stamping, brushing, injecting from a nozzle or needle, or ultrasonic spraying.

In step 120, the first label is wrapped around the shaped container until the trailing edge contacts the leading edge, creating a seam that joins the trailing edge of the first label to the leading edge of the first label with the seaming agent. The seam may have an immediate welding strength (IWS) of at least 2 grams, obtained within a delta period of about 0.5 seconds to about 0.06 seconds, measured upon a seam that has an area of 250 mm² of the label film, prior to exposing the seam to radiation.

In the present disclosure, unlike hot melt technology, the strength of the high-shrink label seam is due to the swelling of the label film with monomers and solvents from the high-shrink seaming agent, leading to mixing of the polymer molecules of the label film with the seaming agent. The Hildebrand solubility parameter of a seaming agent component (monomer and/or solvent) and at least one outer layer of the label film material are close to each other. In this regard, the label film can be a single-layer film or a multi-layer film having at least one outer or external layer. The single layer of the single-layer film should also be considered an outer or external layer. If the solubility parameters are not close, then the immediate welding strength will not be high enough, and the seam will not have a seam quality of 2, 3, or 4 after shrinkage or steam heat shrinkage (which is relevant for high-shrink labels). It is important to note that an immediate welding strength of at least 2 grams only predicts the ability of the seam to remain intact during travel towards the radiation curing tunnel, and does not the ability to withstand heat shrinkage. This is discussed in more detail further herein. On the other hand, if the monomer or solvent content of the seaming agent is too high, the swelling process can affect the clarity of the seam, and the label film may become cloudy, opaque or hazy. This is undesirable. Thus, the seaming agents of the present disclosure generally have a balanced content between monomers+solvent (important for immediate welding and a good seam after shrinkage, but risk of loss of clarity) and oligomers+polymers (which lowers IWS but helps provide a clear seam after shrinkage and suppress loss of clarity), as will be explained further below.

In step 125, the welded seam of the first label is then exposed to radiation to form a cross-linked seam. The radiation initiates crosslinking of the first seaming agent with the interfaces of the first label, resulting in a blend of first seaming agent and polymer molecules from the first label film. The cross-linked welded seam will contain an interpenetrating polymer network (IPN) of (a) cross-linked seaming agent components and polymerized seaming agent chains and (b) polymeric chains from the first label film. The IPN is extremely strong and resistant to cleavage. The forces between the polymerized and cross-linked seaming agent and film polymer chains may be van der Waals, polar, hydrogen, ionic, covalent, coordinative, and combinations thereof. The radiation may be provided by any number of bulbs or light-emitting diodes (LEDs), including combinations thereof. The radiation may have at least one peak wavelength of about 300 nm to about 500 nm. The seam may be exposed to radiation at an average power density of at least 0.2 W/cm² or preferably at least 0.5 W/cm², or even more preferably at least 1 W/cm² as measured on the surface of the shaped article. The seam may be exposed to radiation for a time period of about 0.05 seconds to about 5 seconds, preferably less than 5 seconds, and including about 0.05 seconds to about 2 seconds. The combination of power density and exposure time should provide an exposure of about 0.5 W·sec/cm² to about 4 W·sec/cm². The power density can be measured, for example, using a radiometer such as the LEDCure™ radiometer offered by EIT within any combination of the four response bands available (340-392 nm, 360-412 nm, 370-422 nm, or 380-432 nm).

The result of this step is a first article having a first label applied thereon. Steps 105-125 can be repeated as desired to obtain a production run of first articles with first labels.

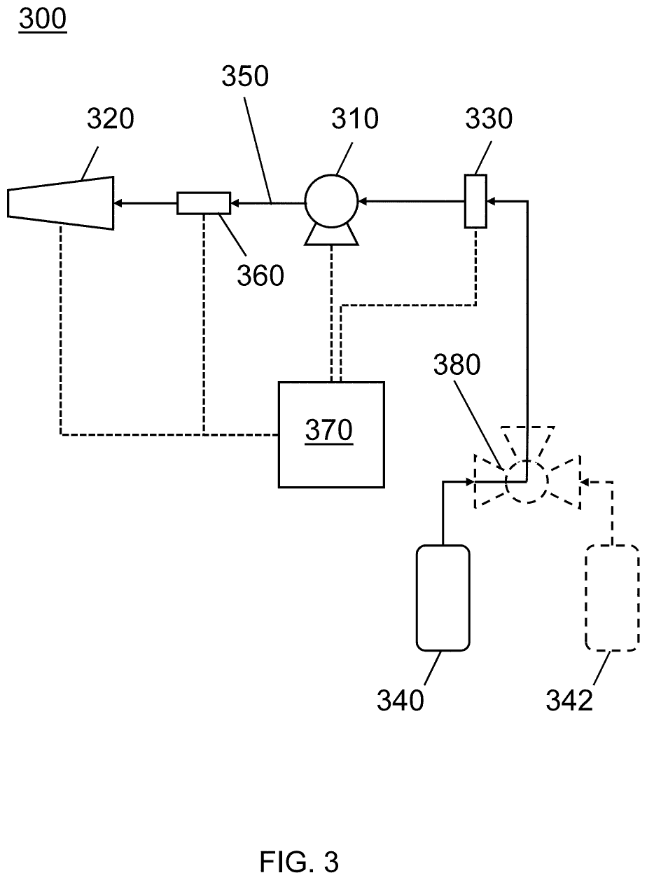

Once the first articles are made using the first seaming agent, the pump-and-meter system (PMS) is configured to use the second seaming agent. FIG. 3 is a schematic diagram illustrating various components of some examples of a general pump-and-meter system. The system 300 includes a pump 310 for pumping the seaming agent through the system. A nozzle 320 is used to dispense seaming agent. A port 330 is present, to which a first fluid source 340 is connected. The fluid source, for example, can be a tank that contains the seaming agent. A fluid passageway 350 (represented by arrows) extends between the port 330 and the nozzle 320. The fluid passageway can include, for example, a hose, valves, etc. The fluid source can feed multiple nozzles if desired. A sensor 360 is used for metering the seaming agent. A computer controller 370 provides information, permits setting of various parameters (e.g. feed rate, temperature, etc.), and controls the dispensing of the seaming agent. Also illustrated in dotted lines are valve 380 and second fluid source 342, which are part of a second example. Here, the valve 380 controls whether fluid enters the fluid passageway through first fluid source 340 or second fluid source 342.

Referring back to FIG. 1 now, in step 130, the PMS is disconnected from the fluid source for the first seaming agent. In step 138, the PMS is connected to a fluid source for the second seaming agent. Again, the first seaming agent is different from the second seaming agent. The PMS is now ready to operate and apply a second label directly to a second article. It is noted that the disconnection does not need to be a physical disconnection. For example, it is contemplated that the first seaming agent fluid source and the second seaming agent fluid source are physically connected to the PMS using separate hoses that lead into a feed valve. This is depicted in FIG. 3. Switching the feed valve 380 to accept fluid from the second seaming agent fluid source 342 instead of the first seaming agent fluid source 340 should also be considered as corresponding to the disconnecting step 130 and connecting step 138. No cleaning of the PMS is needed, because the two seaming agents are soluble in each other.

Referring again to FIG. 1, in step 145, the second label is cut directly from a roll of film. This roll of film is different from that used to make the first label. In step 150, the leading edge of the second label is bonded to a second article. In step 155, the single pump-and-meter system (PMS) is used to apply a second seaming agent to the leading edge of the second label or the trailing edge of the second label. In step 160, the second label is wrapped around the second article until the trailing edge contacts the leading edge, creating a seam that joins the trailing edge of the second label to the leading edge of the second label with the second seaming agent. In step 165, the welded seam of the second label is then exposed to radiation to form a cross-linked seam. The result of these steps is a second article having a second label applied thereon. Steps 145-165 can be repeated as desired to obtain a production run of second articles with second labels. The discussion of steps 105-125 with respect to the various details also applies in equal measure to these steps.

Either the first label or the second label is a high-shrink label (and accordingly is usually applied to a shaped article). The high shrink wrap label(s) can subsequently be heat-shrinked, so that the label conforms to the article. This is identified in step 180. The heat-shrinking may be performed by steam shrink. The heat-shrinking may occur at a temperature of 80° C. or greater, or from 95° C. to about 125° C. The high shrink wrap label may shrink by about 25% or greater, including from about 25% to about 75%.

The label can be applied directly to an article. In this regard, the low-shrink labels can be produced first using the single pump-and-meter system (PMS) and the high-shrink labels can be produced second, or vice versa.

Seaming Agent

Two different seaming agents will be used in the methods of the present disclosure, one for the low-shrink label and one for the high-shrink label. They are referred to as the “low-shrink seaming agent” and the “high-shrink seaming agent” herein.

The low-shrink seaming agent and the high-shrink seaming agent should be compatible with each other. As previously explained, this means the two seaming agents should be soluble in each other at a ratio (w/w) of 1:10 to 10:1. Put another way, the low-shrink seaming agent should dissolve in the high-shrink seaming agent, and the high-shrink seaming agent should dissolve in the low-shrink seaming agent. The result should be a clear solution that is not hazy, and does not cause the seam to be hazy or lose its functionality.

The low-shrink seaming agent and the high-shrink seaming agent will only be compatible with each other if they are both polar seaming agents, or if they are both non-polar seaming agents. If they are both soluble in THFA, the two seaming agents are polar seaming agents. Both the polar low-shrink seaming agent and the polar high-shrink seaming agent should be soluble in tetrahydrofurfuryl acrylate (THFA) at a ratio (w/w) of 1:10 to 10:1. This generally means that all components in each polar seaming agent are also soluble in THFA.

Similarly, if the two seaming agents are both soluble in IBOA, the two seaming agents are non-polar seaming agents. Both the non-polar low-shrink seaming agent and the non-polar high-shrink seaming agent should be soluble in isobornyl acrylate (IBOA) at a ratio (w/w) of 1:10 to 10:1. This generally means that all components in each non-polar seaming agent are also soluble in IBOA.

Regardless of whether they are polar seaming agents or non-polar seaming agents, both the low-shrink seaming agent and the high-shrink seaming agent should have an immediate welding strength of at least 2 grams, which desirably develops within 0.5 seconds when applied on the appropriate film. Both the low-shrink seaming agent and the high-shrink seaming agent should also have a viscosity of less than 1000 centipoise when measured at any temperature between ambient temperature and 60° C. Both seaming agents should polymerize and crosslink when exposed to radiation having at least one peak wavelength of about 300 nm to about 500 nm.

Two different sets of seaming agents are contemplated. The first set includes a polar low-shrink seaming agent and a polar high-shrink seaming agent. The second set includes a non-polar low-shrink seaming agent and a non-polar high-shrink seaming agent. A polar seaming agent cannot be used in the single PMS with a non-polar seaming agent, because they will not definitely be compatible with each other.

Low-Shrink Seaming Agent

The low-shrink seaming agent may be polar or non-polar. Generally, the low-shrink seaming agents have three properties. First, they have a viscosity of about 1000 centipoise or less when measured at any temperature between ambient and 60° C. In particular embodiments, the low-shrink seaming agent has a viscosity of about 300 cP to about 1000 cP. Second, they have an immediate welding strength of at least 2 grams that develops within 0.5 seconds when applied to biaxially oriented polypropylene (BOPP), biaxially oriented polyethylene terephthalate (BOPET), or cast polypropylene (CPP). Desirably, the IWS develops within 0.2 seconds, or within 0.06 seconds. Third, they can obtain a seam quality of at least 2 when applied to biaxially oriented polypropylene (BOPP), biaxially oriented polyethylene terephthalate (BOPET), or cast polypropylene (CPP).

In some particular embodiments, the low-shrink seaming agent (polar or non-polar) may comprise: from 0 to about 50 wt % of an acrylate monomer having a molecular weight of 300 daltons (Da) or less; 0 to about 75 wt % of an oligomer or polymer having a viscosity lower than 200,000 centipoise when measured at a temperature between 20° C. and 70° C.; 0 to about 70 wt % of a tackifying agent; and from about 0.5 wt % to about 15 wt % of a photoinitiator.

In more particular embodiments, the low-shrink seaming agent (polar or non-polar) may comprise: from 5 to about 30 wt % of an acrylate monomer having a molecular weight of 300 daltons (Da) or less; 5 to about 75 wt % of an oligomer or polymer having a viscosity lower than 200,000 centipoise when measured at a temperature between 20° C. and 70° C.; 0 to about 70 wt % of a tackifying agent; and from about 0.5 wt % to about 15 wt % of a photoinitiator.

Examples of acrylate monomers suitable for use in the low-shrink seaming agent include isobornyl acrylate (IBOA); tetrahydrofurfuryl acrylate (THFA); hexanediol diacrylate (HDDA); urethane acrylate; aliphatic acrylates such as cyclohexyl acrylate, hexyl acrylate, and 4-tert-butylcyclohexy acrylate; trimethyl cyclohexyl acrylate; alkyl acrylates; alkyl methacrylates; tricyclodecanedimethanol acrylate; benzyl acrylate; lauryl acrylate; isodecyl acrylate; phenoxy benzyl acrylate; ethoxylated aryl acrylate; alkylated phenyl acrylate; mono-, di-, tri-, tetra-, or poly-acrylates or -methacrylates of polyhydric alcohols, including ethoxylated or propoxylated polyhydric alcohols; 2-(2-ethoxyethoxy)ethyl acrylate (EOEOEA); and phenyl acrylate. More than one such monomer can be used in the low-shrink seaming agent.

Examples of oligomers or polymers that have a viscosity lower than 200,000 centipoise when measured at a temperature between 20° C. and 70° C., and are suitable for use in the polar or non-polar low-shrink seaming agent include ethoxylated or propoxylated polyhydric alcohols such as MIRAMER M3130 and MIRAMER M600. MIRAMER M3130 is an acrylic acid ester, an ethoxylated trimethylolpropane triacrylate, and has a molecular weight of ˜428 Da. MIRAMER M600 is an acrylic acid ester, dipentaerythritol hexaacrylate, and has a molecular weight of ˜528 Da. More examples are polyvinyl butyral; oligomers of butyl acrylate; aliphatic polyesters; urethane acrylate; acrylated or methacrylated hyperbranched alcohols; ethoxylated diglycidyl ether of bisphenol A diacrylate; polyacrylates of hyperbranched alcohols; blends of urethane acrylate and monomer, such as Genomer 4188/EHA; blends of inert resin and monomer such as Genomer 6043/M22; and dipentaerythritol pentaacrylate. More than one such oligomer can be used in the low-shrink seaming agent.

The photoinitiator used in the low-shrink seaming agent is generally a free-radical generator. Upon absorption of radiation, the photoinitiator undergoes hemolytic cleavage to produce free radicals. Examples of photoinitiators suitable for the seaming agent include phosphine oxides such as diphenyl(2,4,6-trimethylbenzoyl) phosphine oxide (TPO); benzoin ethers; benzyl ketals; alkyl phenones; benzophenones; thioxanthones; titanocenes; and acetophenones such as hydroxyacetophenone. The photoinitiator can be present in amounts up to 10 wt % of the low-shrink seaming agent. Examples of suitable photoinitiators are: 1-Hydroxycyclohexyl phenyl ketone (IRGACURE 184); 2,4,6-Trimethylbenzoyl-diphenyl-phosphineoxide (DAROCUR TPO); and phenyl bis(2,4,6-trimethylbenzoyl) phosphine oxide (IRGACURE 819).

Tackifying agents increase the tack (i.e. the stickiness of the surface) of the seaming agent. They are usually low-molecular weight compounds with high glass transition temperature. Examples of tackifying agents include rosins and their derivatives; terpenes and modified terpenes; aliphatic, cycloaliphatic and aromatic resins (C5 aliphatic resins, C9 aromatic resins, and C5/C9 aliphatic/aromatic resins); hydrogenated hydrocarbon resins and their mixtures; and terpene-phenol resins (TPR, used often with ethylene-vinyl acetate adhesives.

High-Shrink Seaming Agent

The high-shrink seaming agent may be polar or non-polar. Generally, the high-shrink seaming agents have two properties. First, they have an immediate welding strength of at least 2 grams, which is developed within 0.5 seconds when measured on an appropriate film (such as PETG, PVC, or PS). Second, they have a viscosity from at least 1 centipoise to about 300 centipoise when measured at any temperature between ambient and 60° C.

In addition, the polar high-shrink seaming agent has a Hildebrand solubility parameter that is within 2.2 MPa^{1/2} or within 4.4 calories^{1/2}·cm^{-3/2} of a Hildebrand solubility parameter of PETG, PVC, or PS. Also, the polar high-shrink seaming agent can obtain a seam quality of at least 2 when applied to PETG, PVC, or PS.

By way of contrast, the non-polar high-shrink seaming agent has a Hildebrand solubility parameter that is within 2.2 MPa^{1/2} or within 4.4 calories^{1/2}·cm^{-3/2} of a Hildebrand solubility parameter of a polyolefin, such as COP or COC. Also, the polar high-shrink seaming agent can obtain a seam quality of at least 2 when applied to COP or COC.

Very generally, the high-shrink seaming agent or composition (polar or non-polar) comprises (A) at least one monomer with a molecular weight lower than 300 daltons (Da); (B) at least one oligomer or polymer or tackifier with a molecular weight greater than 300 daltons (Da) and having good compatibility with the monomer; (C) a photoinitiator; and (D) optionally, a compatible solvent to assist in swelling of the label film. Other ingredients in the seaming agents can include a plasticizer.

The monomer with a molecular weight lower than 300 Da (A) should have good compatibility with an outer layer of the label film, so that the monomer can swell and dissolve the label film material. Additionally, a solvent can be present that dissolves the label film material.

The compatibility between the monomer/solvent and the label film material can be determined by using the Hildebrand solubility parameter, which can be used to estimate whether the label film material will dissolve in the monomer/solvent. The Hildebrand solubility parameter (6) is the square root of the cohesive energy density, and has the SI unit of Pa^{1/2}, and conventional units of calories^{1/2}·cm^{-3/2}. A rough conversion between these two units is that the number of MPa^{1/2} is twice the number of calories^{1/2}·cm^{-3/2}.

Table A lists several monomers and solvents and their Hildebrand solubility parameter.

TABLE A

| Monomer or Solvent | δ (cal^{1/2} · cm^{-3/2}) | δ (MPa^{1/2}) |
|---|---|---|
| 2,2-dimethylpropane (neopentane) | 6.3 | 12.8 |
| Isobutylene | 6.7 | 13.7 |
| n-butane | | 14.1 |
| n-pentane | 7.0 | 14.4 |
| n-hexane | 7.24 | 14.9 |
| Tetrachlorosilane | 7.4 | 15.1 |
| Diethyl Ether | 7.4-7.6 | 15.1-15.4 |
| n-octane | 7.6 | 15.5 |
| methylcyclohexane | 7.8 | 15.9 |
| Limonene | | 16-17 |
| Isooctyl acrylate | 7.8 | 16.0 |
| Ethyl isobutyrate | 7.9 | 16.1 |
| n-butyl cyclohexane | | 16.2 |
| Hexadiene acrylate | 7.9 | 16.2 |
| di-isopropyl ketone | 8.0 | 16.3 |
| Methyl amyl acetate | 8.0 | 16.3 |
| Turpentine | 8.1 | 16.5 |
| 2,2-dichloropropane | 8.2 | 16.7 |
| cyclohexane | 8.2 | 16.8 |
| Sec-amyl acetate | 8.3 | 16.9 |
| Dipentene | 8.5 | 17.3 |
| Amyl acetate | 8.5 | 17.3 |
| n-butyl benzene | | 17.4 |
| 3-n-butyl toluene | | 17.4 |
| p-n-butyl toluene | | 17.4 |
| o-n-butyl toluene | | 17.6 |
| Methyl n-butyl ketone | 8.6 | 17.6 |
| Pine oil | 8.6 | 17.6 |
| Carbon tetrachloride | 8.6 | 17.6 |
| 1,2-diethyl benzene | | 17.7 |
| Methyl n-propyl ketone | 8.7 | 17.8 |
| Piperidine | 8.7 | 17.8 |
| p-xylene | 8.8 | 17.9 |
| ethyl benzene | | 17.9 |
| 1,3,5-trimethyl benzene | | 18.0 |
| Dimethyl ether | 8.8 | 18.0 |
| o-xylene | | 18.1 |
| toluene | 8.9 | 18.2 |
| Ethyl Acetate | 9.1 | 18.2 |
| 1,2-dichloropropane | 9.0 | 18.3 |
| Mesityl oxide | 9.0 | 18.3 |
| Ethoxy ethoxyethylacrylate | 9.0 | 18.4 |
| Benzene | 9.2 | 18.5 |
| Isophorone | 9.1 | 18.6 |
| Ethyl acetate | 9.1 | 18.6 |
| Diacetone alcohol | 9.2 | 18.7 |
| Chloroform | 9.2-9.3 | 18.7-19 |
| Isobornyl acrylate | 9.2 | 18.8 |
| Trichloro ethylene | | 19.0 |
| Trichloroethylene | 9.3 | 19.0 |
| Tetrahydrofurfuryl acrylate | 9.3 | 19.0 |
| styrene | | 19.1 |
| Tetrachloroethylene | 9.4 | 19.2 |
| Tetrahydrofuran | | 19.4-19.5 |
| Tetrahydro naphthalene (tetralin) | 9.5 | 19.4-19.9 |
| Acetone | 9.8-10 | 19.9-20.4 |
| Methyl chloride | 9.7 | 19.8 |
| Methylene dichloride | 9.7 | 19.8 |
| Ethylene dichloride | 9.8 | 20.0 |
| 1,1,2-trichloro ethane | | 20.1 |
| naphthalene | | 20.2 |
| Dichloromethane | 9.93 | 20.2 |
| Cyclohexanone | 9.9 | 20.2 |
| dioxane | 9.9 | 20.2 |
| Carbon disulfide | 10.0 | 20.4 |
| Acetone | 10.0 | 20.4 |
| n-octanol | 10.3 | 21.0 |
| Butyronitrile | 10.5 | 21.4 |
| biphenyl | | 21.5 |
| 1,1,2,2-tetrachloro ethane | | 21.6 |
| n-hexanol | 10.7 | 21.8 |
| 2-propanol | 11.6 | 23.8 |
| Hydroxyethyl methacrylate | | 25-26 |
| Ethanol | 12.92 | 26.5 |
| Ethylene Glycol | | 29.9 |
| Polydimethyl siloxane | 7.6 | 15.5 |
| Poly(isobutylene) (PIB) | | 15.8 |
| Poly(propylene) | 8.2 | 16.2-16.6 |
| Polyisoprene (PI) | | 16.5 |
| Poly(ethylene) | 7.9 | 16.7 |
| Polybutadiene (PB) | | 17.0 |
| Poly(oxypropylene) (PPG) | | 17.2 |
| Poly(tetrahydrofuran) (PTMO, PTMG) | | 17.5 |
| Poly(n-butyl acrylate) | 8.7 | 17.8 |
| Poly(butyl methacrylate) (PBMA) | | 17.9 |
| Poly(isobutyl methacrylate) (PIBMA) | | 18.0 |
| Poly(2-chloro-1,3-butadiene) (Neoprene) | | 18.1 |
| Poly(isobutyl acrylate) | | 18.2 |
| Poly(butyl vinyl ether) | | 18.2 |
| Poly(methyl vinyl ether) | | 18.3 |
| Poly(styrene) | 9.13 | 18.4 |
| Poly(ethyl methacrylate) (PEMA) | | 18.4 |
| Poly(α-methylstyrene) | | 18.4 |
| Poly(2-ethoxyethyl methacrylate) | | 18.6 |
| Poly(vinyl propionate) | | 18.6 |
| Poly(vinyl butyrate) | | 18.6 |
| Poly(propyl acrylate) (PPA) | | 18.7 |
| Poly(methyl methacrylate) | 9.3 | 19.0 |
| Poly(ethyl acrylate) (PEA) | | 19.1 |
| Poly(methyl vinyl thioether) | | 19.1 |
| PVC | 9.5 | 19.5 |
| Poly(vinyl acetate) (PVA) | | 19.6 |
| Poly(epichlorohydrin) | | 19.7 |
| Poly(methyl acrylate) (PMA) | | 20.0 |
| Polylactic acid (PLA) | | 20.2 |
| Poly(vinylidene chloride) (PVDC) | | 20.6 |
| Polyoxyethylene (PEO, PEG) | | 20.8 |
| Poly(oxymethylene), Polyacetal (POM) | | 21.1 |
| Polysulfone (PSU) | | 21.2 |
| Poly(methacrylonitrile) (PMAN) | | 22.9 |
| Poly(octano-8-lactam) (Nylon 8) | | 24.7 |
| PET | 10.1 | 20.5-21.2 |
| Poly(caprolactam) (Nylon 6) | | 25.5 |
| Poly(hexamethylene adipamide) | | 26.1 |
| (Nylon 6,6) | | |
| Poly(acrylonitrile) (PAN) | | 26.2 |
| Poly(cyanomethyl acrylate) | | 26.3 |
| poly(hydroxyethyl methacrylate) | | 26.93 |
| Poly(vinyl alcohol) (PVA, PVOH) | | 30.5 |

For example, polystyrene has a solubility parameter of 9.13 cal^{1/2}·cm^{-3/2}, and thus ethyl acetate or toluene are likely to be good solvents. In the present application, the high-shrink seaming agent contains at least one component that will dissolve the film material from which the high shrink wrap label is made. The (A) at least one component of the high-shrink seaming agent and (B) the film material of the high shrink wrap label are compatible if they have Hildebrand solubility parameters that are within 2.2 MPa^{1/2} or within 4.4 calories^{1/2}·cm^{-3/2} of each other. The component of the high-shrink seaming agent that is compatible with the film material is generally a monomer or a solvent.

Whether the at least one oligomer or polymer with a molecular weight greater than 300 daltons (Da) should be compatible with the monomer (A) or the optional solvent can be determined by a method called “OPMC—Oligomer or Polymer monomer compatibility”. This is done by blending the oligomer/polymer with the monomer/solvent. They are blended at weight ratios (monomer/solvent to oligomer/polymer) of 10:1, 5:1, and 1:1. If all three of these solutions are clear, then the oligomer/polymer is considered to be compatible with the monomer or solvent, and suitable to be used with the monomer or solvent. The oligomer or polymer may be dissolved in the monomer or the solvent, for ease of blending.

In particular embodiments, the high-shrink seaming agent (polar or non-polar) comprises (A) from about 20 wt % to about 99 wt % of at least one monomer with a molecular weight lower than 300 daltons (Da); (B) 0 to about 75 wt % of at least one oligomer or polymer with a molecular weight greater than 300 daltons (Da) and having good compatibility with the monomer; (C) up to about 15 wt % of a photoinitiator; and (D) 0 to about 50 wt % of a compatible organic solvent. The seaming agent may equal 100 wt % of these four components.

In some particular embodiments, the high-shrink seaming agent (polar or non-polar) comprises: (A) from about 20 wt % to about 99 wt % of at least one acrylic or methacrylic acid ester or amide or carbamate monomer having a molecular weight lower than 300 daltons (Da) and having good compatibility with the label film; (B) 0 to about 75 wt % of at least one acrylic or methacrylic acid ester or amide or carbamate or any other oligomer or polymer having a molecular weight greater than 300 daltons (Da) and having good compatibility with the monomer; (C) a photoinitator; (D) 0 to about 40 wt % of a tackifying agent or polymer; (E) 0 to about 50 wt % of an organic solvent; and optionally (F) an adhesion promoter. The seaming agent may equal 100 wt % of these six components.

In further particular embodiments, the high-shrink seaming agent (polar or non-polar) comprises: (A) from about 25 wt % to about 98 wt % of a monomer having a molecular weight of 300 daltons or less; (B) from 0 to about 70 wt % of an organic solvent having a molecular weight of 300 daltons or less; (C) from 0 wt % to about 50 wt % of an oligomer or polymer having a molecular weight of 300 daltons or greater; and (D) from 0.5 about wt % to about 15 wt % of a photoinitiator. The monomer or the organic solvent has a Hildebrand solubility parameter that is within 2.2 MPa^{1/2} or within 4.4 calories^{1/2}·cm^{-3/2} of a Hildebrand solubility parameter of an outer layer of the first label or an outer layer of the second label. The seaming agent may equal 100 wt % of these four components.

Examples of monomers with a molecular weight of less than 300 daltons that have a solubility parameter suitable for swelling the PS group; polyethylene terephthalate glycol-modified (PETG); and polyvinyl chloride (PVC) include tetrahydrofurfuryl acrylate (THFA). THFA has a molecular weight of 156.2 Da. Another example is an acrylic acid ester, hexanediol diacrylate, which has a molecular weight of ˜226 Da, and is available commercially as MIRAMER M200. Cyclic trimethylolpropane formal acrylate (CTFA) is another suitable monomer, which has a molecular weight of 200 Da. More than one such monomer can be used in the high-shrink seaming agent.

Examples of oligomers with a molecular weight of greater than 300 daltons include ethoxylated or propoxylated polyhydric alcohols such as MIRAMER M3130 and MIRAMER M600. MIRAMER M3130 is an acrylic acid ester, an ethoxylated trimethylolpropane triacrylate, and has a molecular weight of ˜428 Da. MIRAMER M600 is an acrylic acid ester, dipentaerythritol hexaacrylate, and has a molecular weight of ˜528 Da. More examples are polyvinyl butyral; oligomers of butyl acrylate; aliphatic polyesters; urethane acrylate; acrylated or methacrylated hyperbranched alcohols; ethoxylated diglycidyl ether of bisphenol A diacrylate; polyacrylates of hyperbranched alcohols; blends of urethane acrylate and monomer, such as Genomer 4188/EHA; blends of inert resin and monomer such as Genomer 6043/M22; hydroxypyvalylpivalate diacrylate (HPPDA); and dipentaerythritol pentaacrylate. More than one such oligomer can be used in the high-shrink seaming agent.

Examples of monomers with a molecular weight of less than 300 daltons that have a solubility parameter suitable for swelling cyclic olefin polymers (COP) or cyclic olefin copolymers (COC) include isobornyl acrylate (IBOA) (208 Da); cyclohexyl acrylate (154 Da); hexyl acrylate (156 Da); and 4-tert-butylcyclohexyl acrylate (210 Da).

The photoinitiator used in the high-shrink seaming agent is generally a free-radical generator. Upon absorption of radiation, the photoinitiator undergoes hemolytic cleavage to produce free radicals. Examples of photoinitiators suitable for the seaming agent include phosphine oxides such as diphenyl(2,4,6-trimethylbenzoyl) phosphine oxide (TPO); benzoin ethers; benzyl ketals; alkyl phenones; benzophenones; thioxanthones; titanocenes; and acetophenones such as hydroxyacetophenone. The photoinitiator can be present in amounts up to 10 wt % of the high-shrink seaming agent, including from about 0.5 wt % to about 2 wt %. Examples of suitable photoinitiators are: 1-Hydroxycyclohexyl phenyl ketone (IRGACURE 184); 2,4,6-Trimethylbenzoyl-diphenyl-phosphineoxide (DAROCUR TPO); and phenyl bis(2,4,6-trimethylbenzoyl) phosphine oxide (IRGACURE 819). In some embodiments, an acrylated amine is also included along with the photoinitiator. This acrylated amine may be present in amount of about 0.2 wt % to about 2 wt % of the seaming agent. Examples of such acrylated amines include GENOMER 5142, which is an acrylated amine synergist.

Tackifying agents increase the tack (i.e. the stickiness of the surface) of the seaming agent. They are usually low-molecular weight compounds with high glass transition temperature. Examples of tackifying agents include rosins and their derivatives; terpenes and modified terpenes; aliphatic, cycloaliphatic and aromatic resins (C5 aliphatic resins, C9 aromatic resins, and C5/C9 aliphatic/aromatic resins); hydrogenated hydrocarbon resins and their mixtures; and terpene-phenol resins (TPR, used often with ethylene-vinyl acetate adhesives). Tackifying agents can be present in amounts up to about 40 wt % of the high-shrink seaming agent. Desirably, however, very little if any tackifying agent is used. This is because the presence of tackifying agent reduces the amount of monomer/solvent available to swell the label film, which can weaken the resulting welded seam.

Examples of organic solvents which can be used in the high-shrink seaming agent to swell COC or COP include aliphatic hydrocarbons such as n-pentene, octane, decane, decalin, or n-hexane; aromatic hydrocarbons such as benzene and benzene derivatives such as toluene; cycloaliphatic hydrocarbons such as cyclohexane and tert butyl cyclohexane; limonene; pinene; pine distillates; and turpentine. Examples of organic solvents which have a solubility parameter suitable for swelling PS, PETG, or PVC include ethers such as ditertbutyl ether, dimethoxyethane, 2-methoxyethyl ether, 1,4-dioxane, tetrahydrofuran (THF), morpholine, and the like; amides such as dimethylformamide, dimethylacetamide, N-methylpyrrolidone, 1,2-dimethyl-2-imidazolidinone, and the like; ketones such as acetone, 2-butanone, 2-pentanone, 3-pentanone, ethyl isopropyl ketone, methyl isobutyl ketone, diisobutyl ketone, and the like; halogenated hydrocarbons such as 1,1,2-trichloro ethane or 1,1,2,2-tetrachloro ethane, chloroform, or dichloromethane; halogenated alcohols; and esters. The organic solvent can be present in amounts up to about 50 wt % of the seaming agent, though it is usually much lower (e.g. less than about 30 wt %, or less than 20 wt %, or less than 5 wt %).

Particular seaming agents are contemplated for use with specific high shrink wrap label film materials. In this regard, high shrink wrap labels can be made from many different materials. These materials include polyolefins such as a cyclic olefin polymer (COP) or a cyclic olefin copolymer (COC); the PS group previously defined; polyethylene terephthalate glycol-modified (PETG); and polyvinyl chloride (PVC); and blends containing one of these polymers. The label film can be a single-layer film or a multi-layer film. In the multi-layer film, the external layer is desirably compatible with the seaming agent. PETG, PVC, and PS are polar materials, and the seaming agents that dissolve these materials are considered polar high-shrink seaming agents. COC and COP are non-polar materials, and the seaming agents that dissolve these materials are considered non-polar high-shrink seaming agents.

When the high shrink wrap label comprises a polyolefin, the high-shrink seaming agent may comprise an acrylic or methacrylic acid ester or amide or carbamate containing a cyclic hydrocarbon group (such as isobornyl acrylate); an acrylic or methacrylic acid ester or amide or carbamate containing a hydrocarbon having a maximum of 20 carbon atoms; or an acrylic or methacrylic acid ester or amide or carbamate containing an aromatic hydrocarbon or heterocyclic group having a maximum of 20 carbon atoms (such 4-tert-butylcyclohexyl acrylate). Examples of cyclic hydrocarbons, aromatic hydrocarbons, and heterocyclic groups that can be present in these esters/amides/carbamates include limonene, pinene, tert butyl cyclohexane, terpinene, monoterpenes, and alkylbenzenes. The seaming agent can alternatively comprise terpene alcohols, fatty alcohols, fatty acid esters, and fatty acid amides, and terpenoids.

When the high shrink wrap label comprises a cyclic olefin polymer (COP) or a cyclic olefin copolymer (COC), the high-shrink seaming agent may comprise a monomer selected from the group consisting of isobornyl acrylate, isobornyl methacrylate, cyclohexyl acrylate, ethyl hexyl acrylate, ethyl hexyl methacrylate, tert-butyl cyclohexyl acrylate, trimethyl cyclohexyl acrylate, alkyl acrylates, alkyl methacrylates, tricyclodecanedimethanol acrylate, styrene, vinyltoluene, benzyl acrylate, lauryl acrylate, isodecyl acrylate, phenoxy benzyl acrylate, ethoxylated aryl acrylate, alkylated phenyl acrylate, and phenyl acrylate. These monomers have a molecular weight lower than 300 daltons (Da).

Continuing, when the high shrink wrap label comprises a cyclic olefin polymer (COP) or a cyclic olefin copolymer (COC), the high-shrink seaming agent may additionally also comprise an oligomer or polymer selected from the group consisting of urethane acrylate, urethane methacrylate, acrylic esters of glycols or diols or polyhydric alcohols, acrylic or methacrylic esters of alkoxylated diols or polyols or polyhydric alcohols, oligomers of acrylic or methacrylic esters, polyvinylbutyral, hydrocarbon resins, polyterpenes, rosin derivatives, polyesters, polystyrene, styrene block copolymers, epoxy acrylates, epoxy methacrylates, phenoxy resins, and acrylated or methacrylated dendritic alcohols, ethoxylated diglycidyl ether of bisphenol A diacrylate; polyacrylates of hyperbranched alcohols; blends of urethane acrylate and monomer, such as Genomer 4188/EHA; and blends of inert resin and monomer such as Genomer 6043/M22. The oligomer or polymer may be dissolved in the monomer or the solvent, for ease of blending.

When the high shrink wrap label comprises a cyclic olefin polymer (COP) or a cyclic olefin copolymer (COC), the high-shrink seaming agent may also comprise a solvent selected from the group consisting of a linear or cyclic or aromatic hydrocarbon having a maximum of 20 carbon atoms, a heterocyclic compound, a terpene alcohol, an alkyl ester, an alkyl amide, cycloaliphatic hydrocarbons, aliphatic hydrocarbons, turpentines, isoparaffins, and paraffins. Examples of suitable hydrocarbons include limonene, pinene, cyclohexane, decane, pentane, alkyl cyclohexane, decalin, xylene, and toluene.

In particular specific embodiments for COP or COC high shrink wrap label films, the high-shrink seaming agent may comprise: from about 25 wt % to about 98 wt % of at least one monomer; from 0 to about 50 wt % of at least one oligomer; 0 to about 50 wt % of an organic solvent; and from about 0.5 wt % to about 15 wt % of a photoinitiator. These components should be selected from the list of appropriate molecules provided above.

In other specific embodiments for COP or COC high shrink wrap label films, the high-shrink seaming agent may comprise: from about 20 wt % to about 98 wt % of a monomer; from 0 wt % to about 45 wt % of an oligomer or polymer; from 0 wt % to about 30 wt % of an organic solvent; from about 1 wt % to about 15 wt % of a photoinitiator; and from 0 wt % to about 20 wt % of a tackifying agent. This seaming agent is especially useful when the high shrink wrap label shrinks more than 25%, but less than 75%. These components should be selected from the list of appropriate molecules provided above for COP and COC films. Seams made with seaming agents according to these specific embodiments will have a seam quality of 2, 3, or 4 (as defined above). Desirably, the monomers and/or solvents dissolve the label film within a period of about 0.5 seconds or less, or about 0.2 seconds or less, or about 0.1 seconds or less, or about 0.06 seconds or less.

In other specific embodiments for COP or COC high shrink wrap label films, the high-shrink seaming agent may comprise: from about 20 wt % to about 98 wt % of a monomer; from 0 wt % to about 45 wt % of an oligomer or polymer; from 0 wt % to about 25 wt % of an organic solvent; from about 1 wt % to about 15 wt % of a photoinitiator; and from 0 wt % to about 20 wt % of a tackifying agent. This seaming agent is especially useful when the high shrink wrap label shrinks more than 25%, but less than 50%. These components should be selected from the list of appropriate molecules provided above for COP and COC films. Seams made with seaming agents according to these specific embodiments will have a seam quality of 2, 3, or 4 (as defined above). Desirably, the monomers and/or solvents dissolve the label film within a period of about 0.5 seconds or less, or about 0.2 seconds or less, or about 0.1 seconds or less, or about 0.06 seconds or less.

In other specific embodiments for COP or COC films, the seaming agent may comprise: from about 20 wt % to about 98 wt % of a monomer; from 0 wt % to about 45 wt % of an oligomer or polymer; from 0 wt % to about 15 wt % of an organic solvent; from about 1 wt % to about 15 wt % of a photoinitiator; and from 0 wt % to about 20 wt % of a tackifying agent. This seaming agent is especially useful when the high shrink wrap label shrinks more than 25%, but less than 40%. These components should be selected from the list of appropriate molecules provided above for COP and COC films. Seams made with seaming agents according to these specific embodiments will have a seam quality of 2, 3, or 4 (as defined above). Desirably, the monomers and/or solvents dissolve the label film within a period of about 0.5 seconds or less, or about 0.2 seconds or less, or about 0.1 seconds or less, or about 0.06 seconds or less.

For high shrink wrap labels that comprise polymers in the PS group previously defined, polyethylene terephthalate glycol-modified (PETG), or polyvinyl chloride (PVC), the high-shrink seaming agent may comprise a monomer that is an acrylic or methacrylic ester, amide, or carbamate having (a) a cyclic ether containing group, such as tetrahydrofurfuryl or dioxane; or (b) an ethoxylated or propoxylated aromatic or aliphatic or cycloaliphatic group, such as alkoxylated phenyl acrylate, ethoxylated glycerol, or ethoxylated trimethylolpropane. The seaming agent can alternatively comprise a monomer that is (c) a monoacrylate or diacrylate or triacrylate or polyacrylate or methacrylate of an alkyl diol or polyol, including hyperbranched alcohols, such as hexanediol diacrylate, butanediol diacrylate, neopentyl glycol diacrylate, or trimethylolpropane mono- or di- or tri-acrylate; (d) a vinyl lactam; (e) an acrylamide or methacrylamide; (f) vinyl pyrrolidone or a similar nitrogen heterocyclic unsaturated monomer; (g) a vinyl morpholine; (h) a lactone or lactam having an acrylate, methacrylate, or vinyl group; (i) a phenyl or alkyl phenol acrylate or methacrylate; (j) an ethoxylated or propoxylated phenyl or alkyl phenol acrylate or methacrylate; (k) a mono- or di- or tri-hydroxyl acid acrylate or methacrylate; (l) an urethane acrylate or methacrylate; (m) an allyl ether; (n) a vinyl ester; (o) a mono-, di-, tri-, tetra-, or poly-acrylate or -methacrylate of a polyhydric alcohol, including an ethoxylated or propoxylated polyhydric alcohol; or (p) 2-(2-ethoxyethoxy)ethyl acrylate (EOEOEA).

Examples of such monomers that can be used with PS, PETG, or PVC high shrink wrap label films are: tetrahydrofurfuryl acrylate (THFA) or caprolactone-modified THFA; cyclic trimethylol propane formal acrylate (CTFA); isobornyl acrylate; isobornyl methacrylate; alkoxylated phenyl acrylate; hexanediol diacrylate; butanediol diacrylate; butanediol dimethacrylates; alkoxylated aliphatic or cycloaliphatic diol diacrylate or dimethacrylate; acrylamide and derivatives thereof; hydroxyethyl acrylate or methacrylate; hydroxypropyl acrylate or methacrylate; acryloyl morpholine; vinyl pyrrolidone; and tricyclodecanedimethanol diacrylate (TCDDA); ethoxylated cyclohexane dimethanol diacrylate (EO-CHMDA); hydroxy pivalic acid neopentyl glycol diacrylate or caprolactone-modified hydroxy pivalic acid neopentyl glycol diacrylate, hydroxypyvalyl pivalate diacrylate (HPPDA), and caprolactone acrylate. These monomers have a molecular weight lower than 300 daltons (Da).

The seaming agent for PS, PETG, or PVC high shrink wrap label films may additionally also comprise an oligomer or polymer selected from the group consisting of urethane acrylate; urethane methacrylate; acrylic or methacrylic esters of glycols or diols or polyhydric alcohols (for example acrylic esters of pentaerythritol); acrylic or methacrylic esters of alkoxylated diols or polyols or polyhydric alcohols (for example ethoxylated trimethylolpropane triacrylate, ethoxylated glycerine triacrylate, ethoxylated dipentaerythritol hexaacrylate); oligomers and polymers of acrylic esters or amides; polyvinylbutyral; hydrocarbon resins; polyterpenes; rosin derivatives including esters of rosin; polyesters (especially low Tg grades, such as ADCOTE resins by Dow, or VITEL resins by Bostik); epoxy resins (for example EPON resins by Resolution); epoxy acrylates; and epoxy methacrylates; phenoxy resins; a resin containing a diglycidyl ether of bisphenol-A; polystyrene; styrene block copolymers or terpolymers; terpene phenols; polyester acrylates or methacrylates; polyurethane; polyesteramide; polymers of acrylic or methacrylic acids or esters or amides (including copolymers and terpolymers thereof); and polyvinyl chloride. The oligomer or polymer may be dissolved in the monomer or the solvent, for ease of blending.

The seaming agent used for PS, PETG, or PVC high shrink wrap label films may comprise a solvent selected from the group consisting of ethers, cyclic ethers, esters, amides, glycol ethers, ketones, aromatics such as toluene, halogenated alcohols, and halogenated hydrocarbons.

In specific embodiments that use PS, PETG, or PVC high shrink wrap label films for the label, the high-shrink seaming agent may comprise: from about 25 wt % to about 98 wt % of a monomer; from 0 to about 75 wt % of an oligomer or polymer; 0 to about 50 wt % of an organic solvent; and from about 0.5 wt % to about 15 wt % of a photoinitiator. These components should be selected from the list of appropriate molecules provided above for PS, PETG, and PVC high shrink wrap label films. Seams made with seaming agents according to these specific embodiments will have a seam quality of 2, 3, or 4. Desirably, the monomers and/or solvents dissolve the label film within a period of about 0.5 seconds or less, or about 0.2 seconds or less, or about 0.1 seconds or less, or about 0.06 seconds or less.

In other embodiments that use PS, PETG, or PVC high shrink wrap label films for the label, the high-shrink seaming agent may comprise: from about 15 wt % to about 90 wt % of a monomer; 0 to about 75 wt % of an oligomer or polymer; 0 to about 20 wt % of an organic solvent; from about 0.5 wt % to about 15 wt % of a photoinitiator; and 0 to about 20 wt % of a tackifying agent. This seaming agent is especially useful when the high shrink wrap label shrinks more than 25%, but less than 50%. These components should be selected from the list of appropriate molecules provided above for PS, PETG, and PVC high shrink wrap label films. Seams made with seaming agents according to these specific embodiments will have a seam quality of 2, 3, or 4 (as defined above). Desirably, the monomers and/or solvents dissolve the label film within a period of about 0.5 seconds or less, or about 0.2 seconds or less, or about 0.1 seconds or less, or about 0.06 seconds or less.

In other embodiments that use PS, PETG, or PVC high shrink wrap label films for the label, the high-shrink seaming agent may comprise: from about 10 wt % to about 90 wt % of a monomer; from 0 wt % to about 80 wt % of an oligomer or polymer; 0 to about 10 wt % of an organic solvent; and from about 0.5 wt % to about 15 wt % of a photoinitiator; and 0 to about 20 wt % of a tackifying agent. This seaming agent is especially useful when the high shrink wrap label shrinks more than 25%, but less than 40%. These components should be selected from the list of appropriate molecules provided above for PS, PETG, and PVC high shrink wrap label films. Seams made with seaming agents according to these specific embodiments will have a seam quality of 2, 3, or 4 (as defined above). Desirably, the monomers and/or solvents dissolve the label film within a period of about 0.5 seconds or less, or about 0.2 seconds or less, or about 0.1 seconds or less, or about 0.06 seconds or less.

In still further embodiments that use PS, PETG, or PVC films for the label, the seaming agent comprises: from about 40 wt % to about 98 wt % of at least one monomer having a molecular weight of less than 300 Da; from about 14 wt % to about 59 wt % of at least one oligomer or polymer having a molecular weight of greater than 300 Da; from about 0.5 wt % to about 2 wt % of a photoinitiator; and from about 0.2 wt % to about 2 wt % of an acrylated amine.

Desirably, the monomer(s) and oligomer(s) are acrylic or methacrylic acid esters or amides or carbamates; or are alkyl diol or polyol diacrylates or dimethacrylates; or are polyacrylates of a polyhydric alcohol. Often, a blend of inert resin and monomer is present.

In still more specific embodiments, the seaming agent comprises: from about 40 wt % to about 50 wt % of cyclic trimethylolpropane formal acrylate; from about 25 wt % to about 35 wt % of either hexanediol diacrylate or hydroxypyvalylpivalate diacrylate; from about 6 wt % to about 12 wt % of dipentaerythritol pentaacrylate and/or dipentaerythritol hexaacrylate; from about 8 wt % to about 12 wt % of a blend of inert resin and monomer (e.g. GENOMER 6043/M22); from about 0.5 wt % to about 2 wt % of a photoinitiator; and from about 0.2 wt % to about 2 wt % of an acrylated amine.

Generally, regardless of the film type, the high shrink wrap label seaming agent desirably contains as little solvent as possible. Ideally, the high-shrink seaming agent contains less than 15 wt % of solvent, and more preferably less than 10%. This is for the same reasons that solvent bonding is hazardous in TD and RFS high shrink label processes. Because the solvent has to evaporate before the welded seam can develop its full strength, this reduces the speed of the label wrapping operation. In addition, solvents have low flashpoints, with consequent implications for safety, fire regulation, VOC control, etc. Solvent can potentially migrate into the container. Finally, solvents usually have a narrow operating window—too much solvent causes whitening or haze in the seam, but too little solvent results in holes in the seam. Desirably, the monomer dissolves the label film. For example, isobornyl acrylate (IBOA) and tetrahydrofurfuryl acrylate (THFA) both have flashpoints over 100° C. In desirable embodiments, the high-shrink seaming agents of the present disclosure have a volatile organic content (VOC) of about 50 wt % or less, including about 25 wt % or less, about 20 wt % or less, about 10 wt % or less, and about 2 wt % or less, and zero % VOC.

The high-shrink seaming agent (polar or non-polar) should have a viscosity of at least 1 centipoise (cPs), including at least 5 cPs, or from about 10 cPs to about 1000 cPs, or from about 5 cP to about 300 cP, or from about 10 cPs to about 450 cPs, or from about 10 cPs to about 300 cPs, or from about 10 cPs to about 250 cPs, or below 250 cPs, or below 200 cPs, when measured at any temperature between ambient temperature and about 60° C. This low viscosity allows the seam area to be completely filled in less than about 0.5 seconds (the typical time available for seam in a high speed bottling process), so no voids are present even in unsupported areas on curved containers, and the edges of the seam are completely wetted so that curling is avoided, without the solvent bleeding out of the seam area. The minimum viscosity for the seaming agent is 1 cPs.

The high-shrink seaming agent combines the ability to swell and dissolve the film of the high shrink wrap label (permitting welding) within less than 0.5 seconds with the ability to polymerize when exposed to radiation. The radiation exposure causes crosslinking and strengthens the mixed seaming agent with the dissolved polymer of the film of the label, so that a welded seam is formed. The bonding of the two edges of the high shrink wrap label is due to co-diffusion of the seaming agent and the film, and is very strong and able to withstand the shrink forces associated with high shrinkage, as well as the heat and humidity of the shrink tunnel. In contrast, with conventional processes, the bonding of the two edges of the label is due to the adhesive layer between them, which is based only on cohesive forces. The adhesive-label interface is weak, and can be easily broken by the shrink forces combined with the heat and humidity of the shrink tunnel.

Each film material for the label has its own compatible seaming agents. This contrasts with conventional processes where a film-agnostic glue is applied that acts as a layer joining two layers of the label (i.e. the leading edge and the trailing edge) together.

### EXAMPLES

The following examples are for purposes of further illustrating the present disclosure. The examples are merely illustrative and are not intended to limit the disclosure to the methods, materials, conditions, or process parameters set forth therein.

### Example 1

Eight different seaming agents E1-E8 were tested for their ability to weld different materials, and for their immediate welding strength, as well as to provide a good seam after heat shrinkage at 0-60% shrinkage. They were made with varying amounts of MIRAMER M200, MIRAMER M600, MIRAMER M3130, tetrahydrofurfuryl acrylate (THFA), isobornyl acrylate (IBOA), and GENOMER 6043/M22 (a blend of monomer and saturated polyester oligomer).

MIRAMER M200 is a semi-polar difunctional monomer (Hexanediol diacrylate) manufactured by Rahn with very low viscosity (6-12 cPs at 23° C. and low molecular weight of 226 Da). MIRAMER M200 has good compatibility with PVC and PS, is partially compatible with PETG, and is incompatible with COC.

MIRAMER M600 manufactured by Rahn is a semi-polar hexafunctional oligomer (dipentaerythritol hexaacrylate) with high viscosity (4000-7000 cPs at 23° C.) and molecular weight of 578 Da. It is useful for controlling cross-linking density, curing speed, and as a barrier to diffusion of monomers and solvents into the film, and is thus useful for reducing haze.

MIRAMER M3130 is a trifunctional oligomer (Trimethylolpropane (EO)n Triacrylate) with medium polarity and medium viscosity (viscosity 50-70 cPs at 23° C. and molecular weight of 428 Da). It is useful for controlling cross-linking density, curing speed, and as a barrier to diffusion of monomers and solvents into the film, and is thus useful for reducing haze.

THFA is a very polar monofunctional monomer with very low viscosity (viscosity 3-12 cPs at 23° C. and molecular weight of 156 Da). THFA has good compatibility with PETG, PVC, and PS, but is incompatible with COC. It is very efficient in providing immediate welding strength and allows swelling of the label and mixing of label molecules with the seaming agent in the interface. However, due to its low molecular weight, it may attack the film during seam formation, even in time periods as short as less than 0.5 seconds, and cause loss of clarity (a hazy and milky film).

Isobornyl acrylate (IBOA) is a non-polar monomer with low viscosity (viscosity 5-15 cPs at 23° C. and molecular weight of 208 Da). IBOA has good compatibility with COC, has some compatibility with PS, and is incompatible with PVC and PETG.

GENOMER 6043/M22 is a blend of urethane acrylate monomer with a thermoplastic polyester resin. It has very high viscosity (30,000 cPs at 23° C.) and is useful as a viscosity adjuster and as a diffusion suppressor to avoid haze in the film during seaming\. It is useful for adjusting cross-linking density (a greater amount of 6043/M22 will soften the cross-linked polymeric matrix and avoid cracks in the seam during shrinkage), and curing speed. It will also act as a barrier to diffusion of monomers and solvents into the film, and thus is useful for reducing haze.

TPO was used as a photoinitiator. This photoinitiator is useful for this application because it absorbs energy not only at 365 nm (like most photoinitiators), but also at 395-430 nm. This is important for three reasons. First, at wavelengths greater than 365 nm, ozone is not generated. This is an important factor because ozone is corrosive and harmful. Second, irradiation at these wavelengths is less harmful to humans. Finally, irradiation at these wavelengths penetrates through aromatic films such as PS and PETG, while shorter wavelengths are blocked.

The solvent used was THF or limonene. THF (Tetrahydrofuran, viscosity 0.48 cPs at 23° C., molecular weight 72 Da) is a very polar solvent, and is suitable for swelling of PVC, PS, and PETG, but is incompatible with COC. Limonene is a hydrocarbon solvent (viscosity 0.9 cPs at 23° C., molecular weight 136 Da) that is compatible with COC but incompatible with PVC, PETG and PS. These solvents are flammable, but surprisingly, when blended with monomers and oligomers according to the present disclosure, the flammability of the seaming agent is more like the flammability of the monomers and oligomers, and the influence of solvent on flammability is minor.

Information on the Examples are listed in Table 1A below.

TABLE 1A

| Ingredient | δ (MPa^{1/2}) | E1 | E2 | E3 | E4 | E5 | E6 | E7 | E8 |
|---|---|---|---|---|---|---|---|---|---|
| M200 monomer (g) | 17-18 | 1.5 | 1.5 | 1.5 | 1.5 | 1.5 | 1.5 | 1.5 | 1.5 |
| M600 oligomer (g) | | 3.7 | 5.4 | 7.4 | 3.7 | 3.7 | 7.4 | 7.4 | 7.4 |
| M3130 oligomer (g) | | 3.7 | 5.4 | — | 3.7 | 3.7 | — | — | — |
| THFA monomer (g) | 19 | 5.5 | 5.5 | — | 5.5 | 5.5 | — | — | — |
| 6043/M22 oligomer(g) | | 1.3 | 5.0 | 1.3 | 1.3 | 1.3 | 1.3 | 6.0 | 1.3 |
| TPO photoinitiator (g) | | 0.6 | 0.6 | 0.6 | 0.6 | 0.6 | 0.6 | 0.6 | 0.6 |
| IBOA monomer (g) | 18.8 | — | — | 5.5 | — | — | 5.5 | 5.5 | 5.5 |
| THF solvent (g) | 19.4-19.5 | — | — | — | 1.6 | 3.2 | — | — | — |
| Limonene solvent (g) | 16-17 | — | — | — | — | — | 3.0 | 3.0 | 5.5 |
| wt % solvent | | — | — | — | 9.0 | 16.5 | 15.6 | 12.5 | 25.3 |
| wt % monomer | | 33.9 | 23.6 | 34.0 | 30.9 | 28.3 | 28.6 | 23.0 | 25.3 |
| wt % oligomer | | 62.7 | 74.1 | 62.7 | 57.1 | 52.4 | 52.9 | 62.2 | 46.8 |

E1 was measured as having a viscosity at room temperature of 25 to 30 cPs, and a viscosity at 60° C. of 11 to 13 cPs.

E2 was measured as having a viscosity at room temperature of 90 to 120 cPs, and a viscosity at 60° C. of 40 to 60 cPs.

E3 was measured as having a viscosity at room temperature of 25 to 45 cPs, and a viscosity at 60° C. of 20 to 30 cPs.

E4 was measured as having a viscosity at room temperature of 20 to 25 cPs, and a viscosity at 60° C. of 8 to 11 cPs.

E5 was measured as having a viscosity at room temperature of 13 to 20 cPs, and a viscosity at 60° C. of 6 to 10 cPs.

E6 was measured as having a viscosity at room temperature of 20 to 32 cPs, and a viscosity at 60° C. of 14 to 24 cPs.

E7 was measured as having a viscosity at room temperature of 44 to 60 cPs, and a viscosity at 60° C. of 25 to 40 cPs.

E8 was measured as having a viscosity at room temperature of 11 to 20 cPs, and a viscosity at 60° C. of 6 to 11 cPs.

The seaming agents were applied to different films: (a) Polyphane FIT ST, a coextruded film with external layers made of a proprietary blend of styrene polymers and polyolefins, machine direction oriented (MDO), manufactured by Polysack Flexible Packaging LTD, thickness 40 microns; (b) Polyphane FIT STS, a coextruded film with external layers made of a proprietary blend of COC polymers and polyolefins, machine direction oriented (MDO), manufactured by Polysack Flexible Packaging LTD, thickness 40 microns; and (c) Klockner Pentalabel® Rigid PETG LF-LG01F19 M65, a PETG MDO film, thickness 40 microns. The films were wrapped around a mandrel for radiation curing. The mandrel had an hourglass shape.

PS has a solubility parameter of 18.4 MPa^{1/2}, and polyolefins have an average solubility parameter of 16.5 MPa^{1/2}, so the outer layers of Polyphane FIT ST have a solubility parameter somewhere between 18.4 and 16.5 MPa^{1/2}. COC has a solubility parameter similar to Polyethylene (˜16.3-16.8 MPa^{1/2}), so the outer layers of Polyphane FIT STS ST have a solubility parameter somewhere between 18.3 and 16.8. PETG has a solubility parameter similar to PET (˜21.2 MPa^{1/2}).

The seaming agent, after achieving welding of the leading edge and the trailing edge within a period of about 0.25 seconds, was cross-linked using exposure to LED radiation (LED unit by Baldwin, model Uved) of peak wavelength 395 nm, 3000 W total power (of which about 40% is UV and the rest heat), 1.5 seconds exposure time, non-focused light, chamber with reflective walls. The reflective UV chamber was designed to permit light to approach the seam, regardless of its alignment toward the LED source. This was done because the radiation curing chamber or tunnel in commercial lines is positioned downstream of the roll fed machine where the container is wrapped by the high shrink wrap label, and so the seam position on the conveyor belt relative to the LED source is usually sporadic. Light is transmitted from the LED source at a wide angle, hitting reflective walls and traveling multiple times, so the container is exposed to light over its entire contour. The wrapped mandrel was removed from the simulating apparatus and transferred to a model S3 steam chamber (Ryback & Ryback Inc.), and steamed at 95° C. to 100° C. for 7 seconds. The shrinkage was from 0 to 60%, based on the geometry of the curved mandrel with little shrinkage at the top and bottom, and 60% shrinkage in the narrow zone in the center of the mandrel. The quality of seam vs. shrinkage is summarized in Table 1B.

TABLE 1B

| | | | SEAM QUALITY |
|---|---|---|---|
| | SEAM QUALITY AFTER | SEAM QUALITY AFTER 0%-60% | AFTER 0%-60% |
| | 0%-60% SHRINK ON | SHRINK ON | SHRINK ON |
| | POLYPHANE FIT ST | POLYPHANE FIT STS | PETG |
| E1 | seam quality 3 or 4 at 0-50% | Seam couldn't hold travel to | seam quality 2 at |
| | shrinkage (shrinkage | radiation curing chamber | 0-25% shrinkage. |
| | over 50% limited by label) | | seam open at |
| | | | shrinkage greater |
| | | | than 30% |
| E2 | seam quality 3 or 4 at 0-50% | Seam couldn't hold travel to | seam quality 2 at |
| | shrinkage (shrinkage | radiation curing chamber | 0-25% shrinkage. |
| | over 50% limited by label) | | seam open at |
| | | | shrinkage greater |
| | | | than 20% |
| E3 | seam quality 3 or 4 at up to | seam quality 2 at up to 35% | Seam couldn't |
| | 30% shrinkage. Seam | shrinkage. Seam open at | hold travel to |
| | quality 2 at shrinkage | shrinkage greater than 35% | radiation curing |
| | greater than 30% because | because of seam brittleness | chamber |
| | of delamination from film. | combined with delaminations | |
| E4 | seam quality 3 or 4 at 0-50% | Seam couldn't hold travel to | seam quality 2 or |
| | shrinkage (shrinkage | radiation curing chamber | 3 at 0-60% |
| | over 50% limited by label) | | shrinkage, |
| E5 | seam quality 3 or 4 at 0-50% | Seam couldn't hold travel to | seam quality 3 or |
| | shrinkage (shrinkage | radiation curing chamber | 4 at 0-60% |
| | over 50% limited by label). | | shrinkage |
| | Some minor loss of film | | |
| | clarity | | |
| E6 | Seam couldn't hold travel to | seam quality 2 or 3 at 0-50% | Seam couldn't |
| | radiation curing chamber | shrinkage. Minor loss of film | hold travel to |
| | | clarity | radiation curing |
| | | | chamber |
| E7 | Seam couldn't hold travel to | seam quality 2 or 3 at 0-50% | Seam couldn't |
| | radiation curing chamber | shrinkageNo lossof film clarity | hold travel to |
| | | | radiation curing |
| | | | chamber |
| E8 | Seam couldn't hold travel to | seam quality 3 or 4 at 0-50% | Seam couldn't |
| | radiation curing chamber | (limited by film) shrinkage, | hold travel to |
| | | Minor loss of clarity. | radiation curing |
| | | | chamber |

E1 is rich in THFA monomer. THFA is very suitable to swell the outer layers of the Polyphane FIT ST, and thus a seam with a seam quality of at least 2 was obtained. THFA is able to swell PETG, but not enough to guarantee a seam with a seam quality of at least 2 above 30% shrinkage. THFA is not compatible with COC and polyolefins, and thus Polyphane FIT STS failed to survive even the travel from wrap around aggregate to radiation curing chamber.

E2 is rich in THFA monomer, but less than E1, because it comprises more oligomers. It is yet very suitable for Polyphane FIT ST, not suitable for Polyphane FIT STS, and able to withstand less shrink forces with PETG.

E3 is rich in IBOA. It is able to swell Polyphane FIT ST, but not as well as THFA. Due to that, the seam opened at shrinkage greater than 35% (interfacial failure). It is able to swell Polyphane FIT STS, but not fast enough (interfacial failure), and due to the content of hexafunctional M600, the cross linking density is too high, and the seam itself is brittle (cohesive failure). IBOA is not compatible with PETG and polyolefins, and thus PETG failed to survive even the travel from wrap around aggregate to radiation curing chamber.

E4 is similar to E1 with the addition of THF solvent. THF is more polar than THFA and has a much lower molecular weight. It allows improved immediate welding strength, improved interfacial strength between seaming agent and label, but may harm label clarity with both PETG and Polyphane FIT ST. However, at this level, a seam with a seam quality of at least 2 was obtained with Polyphane FIT ST. THF is able to swell PETG, much stronger and faster than THFA, so a seam with a seam quality of at least 2 up to 50% shrinkage was obtained with PETG. However, more THF required improving the welding strength to withstand shrink forces greater than 50%. THF is not compatible with COC and polyolefins, and thus Polyphane FIT STS failed to survive even the travel from wrap around aggregate to radiation curing chamber.

E5 is similar to E4 with the addition of more THF solvent. At this level, a seam with a seam quality of at least 2 was obtained with Polyphane FIT ST at up to 50% shrinkage. There was minor impact on film clarity, but it was negligible. Addition of THF allowed a seam with a seam quality of at least 2 up to 60% shrinkage with PETG. THF is not compatible with COC and polyolefins, and thus Polyphane FIT STS failed to survive even the travel from wrap around aggregate to radiation curing chamber.

E6 and E7 are variations of E3, with similar amounts of limonene solvent and differences in oligomer content. Both improved ability to hold shrink forces (from 35% to 45%) but not enough to withstand shrink forces up to 50%. Since limonene is more non-polar relative to IBOA, swelling of Polyphane FIT ST and PETG was poor and thus E6 and E7 are not suitable for use with them.

E8 is the same as E6, but with almost double the amount of limonene solvent. The addition of limonene allowed better adhesion, so the seam can withstand shrink forces up to 50%. The addition of limonene affected film clarity as expected, but it was very minor. E8 is a very suitable seaming agent for Polyphane FIT STS, but not for Polyphane FIT ST and PETG.

Overall, Table 1B demonstrated some important conclusions. It is possible to match solubility, swelling rate, cross link density and viscosity so that for each type of label film, an optimal seaming agent could be selected. This requires careful balancing between contradicting factors (swelling vs. haze, cross-linking density vs. brittleness).

### Example 2

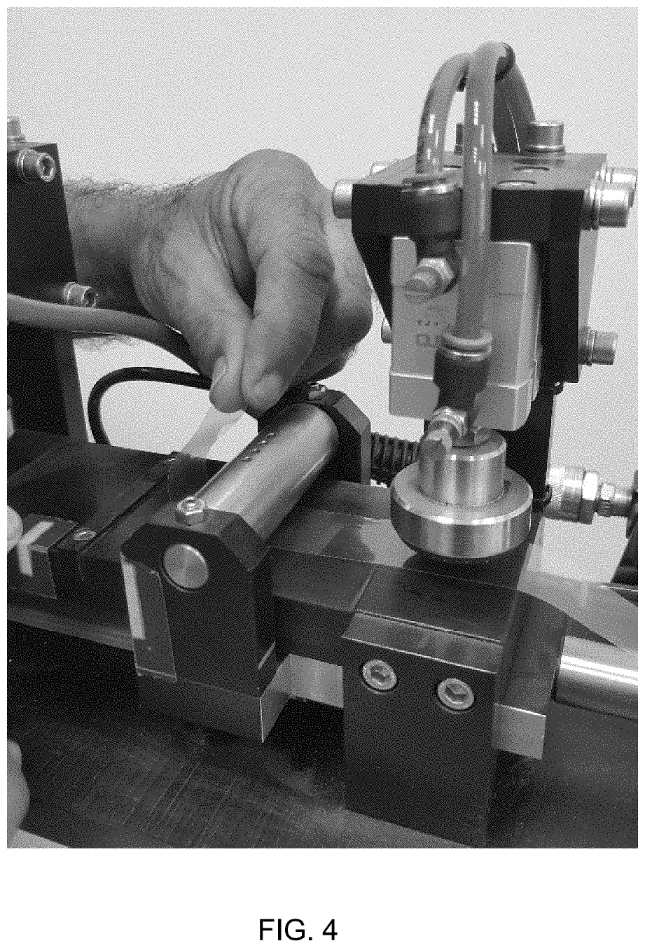

In order to demonstrate the correlation between seam quality and immediate welding strength, an immediate welding strength test was conducted on seaming agents E1-E8. FIGS. 4-7 illustrate how an immediate welding strength test was performed using two strips with a width of 25 mm, a length of 200 mm, and a seam made from a 10 mm overlap on the strip. A device with two pistons was used.

FIG. 4 is a first picture illustrating the immediate welding strength test. A first strip of 25 mm wide, made of a high shrink film, is used to simulate leading edge of the label, attached to a vacuum drum and clamped by first right clamp.

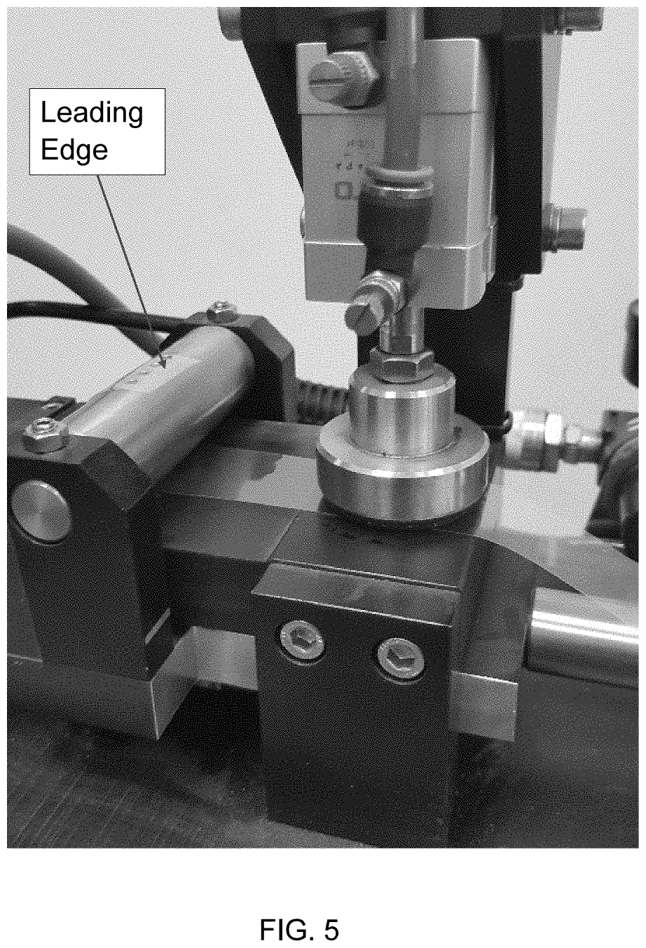

FIG. 5 shows the leading edge wrapped around the vacuum drum and clamp pressed to keep the first strip from moving.

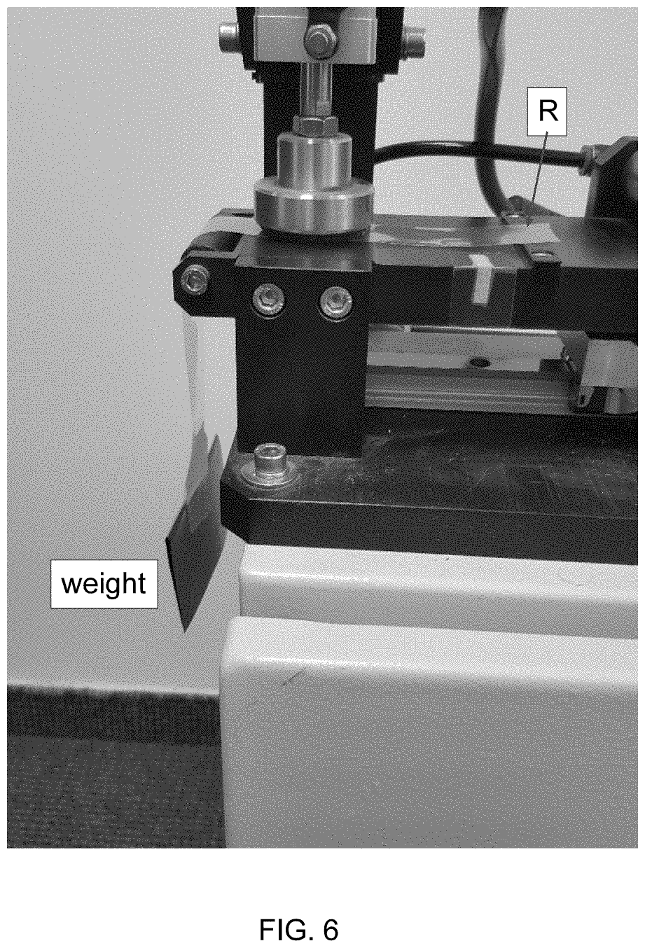

FIG. 6 is a third picture of the immediate welding strength test, showing a second strip of same film type and width (simulating the trailing edge) being held by the left piston of the test device. One edge of the second strip is located on a ramp, simulating the ramp on drum that allows the leading edge and the trailing edge to contact each other. Seaming agent was applied to this edge by a 6 mm wide brush, dispensing 1-2 mg of seaming agent on the area on top of ramp R. The other edge of the second strip hangs over the edge, and a load is applied. The left piston secures the left strip from falling due to the applied load. When the system is activated by electrical trigger, the drum rotates toward the ramp, so the leading edge of the first strip contacts the seaming agent on the second strip on the ramp. The seaming agent flows (via capillary action) to fill the complete overlap of 10 mm long (so the surface area of the seam is 25 mm×10 mm). The right piston remains closed, while the left piston opens and releases the left strip, within a pre-defined delta time after the leading edge is released to fall onto the seaming agent. This delta time simulates the time on the wrap around machine when the seam is released from the vacuum drum, where the seam must withstand accelerations on the conveyor belt to the radiation-curing tunnel. Typical delta time periods on wrap around machines vary between 40 milliseconds (ms) on extremely fast production lines to 0.5 seconds (500 ms) for slow production lines.

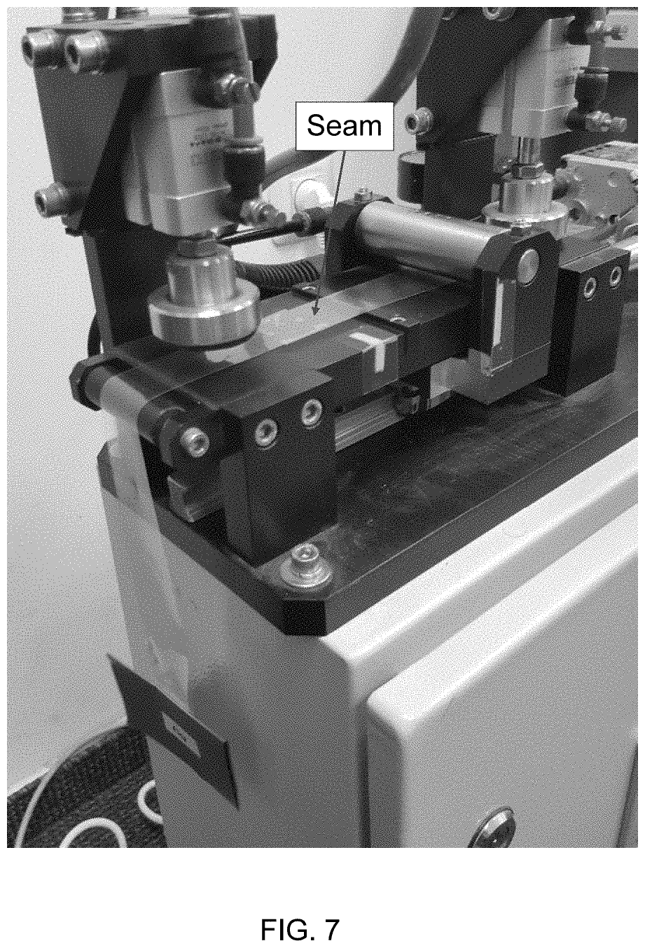

FIG. 7 is a fourth picture of the immediate welding strength test. This shows the seam on the testing machine after releasing of the left piston. Here, the seaming agent was strong enough to hold against the applied load.

The data generated by this method includes: film type, seaming agent type, load, delta time period, and pass or fail.

The three different films were tested with the different Examples E1-E8. After a delta time delay of 0.2 seconds, the maximal load that the seam could bear before separating was recorded. Table 2 contains information on the results for each of the seaming agents and the three different film types. Any value of 2 or greater is a good result, but values of 4.5 grams or greater are preferred.

TABLE 2

| | immediate welding | immediate welding | immediate welding |
|---|---|---|---|
| | strength on Polyphane | strength on Polyphane | strength on PETG |
| | FIT ST (g) | FIT STS (g) | (g) |
| E1 | 4.5 | does not weld | 2.0 |
| E2 | 4.5 | does not weld | 2.0 |
| E3 | 3.0 | 4.5 | does not weld |
| E4 | 6.0 | does not weld | 4.5 |
| E5 | 6.0 | does not weld | 6.0 |
| E6 | 2.0 | 4.5 | does not weld |
| E7 | 2.0 | 6.0 | does not weld |
| E8 | 2.0 | 6.0 | does not weld |

It is clear that there is very good agreement between immediate welding strength results and seam quality in the wrap around test. Seaming agents incompatible with the label film failed to provide sufficient immediate welding, as well as resistance against shrink forces. A balance is necessary, because too much solvent or compatible monomer may guarantee immediate welding and resistance against shrink forces, but also negatively affect label seam quality.

### Example 3

Examples of seaming agents that are compatible with high-shrink labels and low-shrink labels are described here. They are identified as HS1-HS4 for high-shrink seaming agents and LS1-LS4 for low-shrink seaming agents.

Genomer 4188/EHA is a blend of aliphatic urethane acrylate and a monomer, manufactured by Rahn.

Piccotac™ 1105-E Hydrocarbon Resin is a low molecular weight, aliphatic hydrocarbon resin, derived mainly from dienes and other reactive olefin monomers. This pale-colored, neutral resin is characterized by its tack and tack retention, excellent binding properties, high resistance to moisture, UV stability, and good compatibility and solubility. It used as a binder and a tackifier resin.

Foral™ AX-E Fully Hydrogenated Rosin is a thermoplastic, acidic resin produced by hydrogenating rosin to an exceptionally high degree. It is used as a tackifier and resin modifier in solvent adhesives and hot-melt applied coatings and adhesives.

Table 3A describes the components in high-shrink seaming agents HS1-HS4. Table 3B describes the components in low-shrink seaming agents LS1-LS4.

TABLE 3A

| | HS-1 | HS-2 | HS-3 | HS-4 |
|---|---|---|---|---|
| Ingredient | polar | polar | Non-polar | Non-polar |
| IBOA monomer | — | — | 25% | 25% |
| THFA monomer | 40% | 30% | — | — |
| Hexanediol diacrylate (M200) | 20% | 20% | 18% | 8% |
| TMP(EO)₃TA triacrylate oligomer | 15% | 15% | 10% | 10% |
| (M3130) | | | | |
| TPO photoinitiator | 5% | 5% | 5% | 5% |
| Piccotac 1105-E tackifier | — | — | — | 5% |
| Gum Rosin Foral AX-E tackifier | — | 5% | — | — |
| 6043/M22 oligomer | 20% | 15% | 25% | 25% |
| Limonene solvent | — | — | 17% | 22% |
| THF solvent | — | 10% | — | — |

TABLE 3B

| | LS-1 | LS-2 | LS-3 | LS-4 |
|---|---|---|---|---|
| Ingredient | polar | polar | Non-polar | Non-polar |
| IBOA monomer | — | — | 30% | 35% |
| Hexanediol diacrylate (M200) | 30% | 30% | 10% | 5% |
| TMP(EO)₃TA triacrylate | 15% | 15% | 5% | 10% |
| oligomer (M3130) | | | | |
| TPO photoinitiator | 5% | 5% | 5% | 5% |
| Piccotac 1105-E tackifier | — | — | 50% | 45% |
| Gum Rosin Foral AX-E tackifier | 50% | — | — | — |
| 4188/EHA oligomer | — | 50% | — | — |

HS-1 and HS-2 were compatible with LS-1 and LS-2. LS-1 is a blend of polar monomer and polar tackifier. This composition is easily further diluted by the polar monomers and solvents of HS-1 and HS-2. LS-2 is a blend of polar monomer and semi polar oligomers. This readily dissolves in the THFA and THF of HS-1 and HS-2.

LS-4 is a blend of hydrocarbon tackifier, non-polar monomer (IBOA), and a small amount of polar monomer (HDDA). It is readily soluble with the IBOA and limonene in HS-1 and HS-2.

HS-1 and HS-2, when mixed with LS-3 or LS-4 (polar HS with non-polar LS) gave hazy turbid solutions that are not acceptable for seaming.

HS-3 and HS-4, when mixed with LS-1 or LS-2 (non-polar HS with polar LS) gave hazy turbid solutions that are not acceptable for seaming.

Four conventional hot melt adhesives were tested for compatibility with THFA, IBOA, HS-1, and HS-3, i.e. did they dissolve in each other. The results are listed in Table 3C.

TABLE 3C

| | Compatible | Compatible | Compatible | Compatible |
|---|---|---|---|---|
| Hot melt adhesive | with THFA? | with IBOA? | with HS-1? | with HS-3? |
| SBS block copolymer + | no | Partial. Only | no | no |
| tackifier + | | swelling. Not | | |
| plasticizer + Wax | | soluble | | |
| SIS block copolymer + | Partial. Only | Partial. Only | no | no |
| tackifier + dimer | swelling. Not | swelling. Not | | |
| acid | soluble | soluble | | |
| Polypropylene | no | no | no | no |
| copolymer + Tackifier + | | | | |
| wax + amorphous | | | | |
| polyolefin | | | | |
| Reactive | Partial. Only | no | Partial. Only | no |
| polyurethane polymer | swelling. Not | | swelling. Not | |
| | soluble | | soluble | |

### Example 4

ASTM D5403-93 relates to measurement of volatile content of radiation curable materials. Generally, a film of cured polymer is heated to 110° C. for 60 minutes and the measured weight loss is identified as being due to the volatiles. Because it is difficult to use this method to measure low amounts of volatiles, and because the seaming agent is swollen between two layers of shrink film, a modified method was used.

In the modified method, a film of length 300 mm and height 250 mm is used. A seaming agent is coated by a wire or roller coater to a thickness of 2-12 microns on one end of the film, over an area of 100 mm×250 mm (25,000 mm²). The film is wrapped around a heat resistant cylindrical mandrel having a diameter of 60 mm and a height of 250 mm. The mandrel is exposed to radiation (medium pressure mercury lamp at minimum 0.1 W/cm² at peak, or LED having peak at 365-430 nm at minimum 0.5 W/cm² at peak), and then heated in an oven at 110° C. for 60 minutes. In the oven, shrinkage will occur, but the mandrel will suppress the shrinkage and keep the surface of film free for evaporation.

The VOC percentage is calculated according to the following equations:

IFW=initial film weight

IFW+SAAC=weight of film+seaming agent after curing

IFW+SAAH=weight of film+seaming agent after heat treatment at 110° C./60 minutes

Seaming agent net weight after curing(SAAC)=(IFW+SAAC)−IFW

Seaming agent net weight after heat treatment=(IFW+SAAH)minus IFW

Net volatiles(NV)=(IFW+SAAC)−(IFW+SAAH)

% VOC=100×NV/SAAC

Five example formulations VOC-1 through VOC-5, and their VOC content, are given in Table 4A based on wt % and the testing procedure described above.

TABLE 4A

| Ingredient | VOC-1 | VOC-2 | VOC-3 | VOC-4 | VOC-5 |
|---|---|---|---|---|---|
| IBOA monomer | 50% | 40% | 40% | — | — |
| THFA monomer | — | — | — | 30% | 45% |
| Hexanediol diacrylate | 10% | 10% | 5% | 10% | 15% |
| (M200) | | | | | |
| TMP(EO)₃TA triacrylate | — | — | 5% | 15% | 10% |
| oligomer (M600) | | | | | |
| TPO photoinitiator | 5% | 5% | 5% | 5% | 5% |
| Piccotac 1105-E tackifier | 25% | 25% | 15% | — | — |
| Gum Rosin tackifier | — | — | — | 20% | 25% |
| Limonene solvent | 10% | 20% | 30% | — | — |
| THF solvent | — | — | — | 20% | — |
| % VOC in seam per | 3 | 7 | 17 | 6 | 0 |
| modified ASTM | | | | | |
| D5403-93 | | | | | |

Some non-obvious and surprising findings were derived from Table 4A. Example VOC-5 shows a zero % VOC formulation can be provided (useful for Polyphane FIT ST). In all formulations, the measured % VOC was about only 30%-50% of the original solvent amount in the formulation. This surprising finding shows a significant portion of solvent is “caged” during radiation curing and thus not emitted into the environment during manufacturing. Example VOC-4 is a very low % VOC formulation useful for Polyphane FIT ST and PETG, allowing reduction of VOC emission by about 16 times relative to conventional solvent bonding (either RFS solvent or TD machines or RF solvent). For example, assuming a typical container with a seam of 900 mm², seaming agent of 1 mg per square centimeter, 600 containers per minute, 20 hours per day, and 330 days per year, an RFS or TD machine will emit about 2000 kg VOC per year, but using Example VOC-4 will only emit about 128 kg VOC per year Example VOC-2, useful for high shrink COC based films such as Polyphane FIT STS, will emit very similar levels of about 130 kg VOC per year.

Examples E1-E8 were also tested for % VOC emission, and the results are presented in Table 4B.

TABLE 4B

| | E1 | E2 | E3 | E4 | E5 | E6 | E7 | E8 |
|---|---|---|---|---|---|---|---|---|
| % VOC | 0 | 0 | 0 | 4.2 | 9 | 6.2 | 11 | 12.5 |

Formulations E1-E3 are suitable for zero % VOC seaming of PS and PVC films. Formulations E4-E5 are suitable for low % VOC seaming of PETG films. Formulations E6-E8 are suitable for low % VOC seaming of COC films. More generally, the seaming agents of the present disclosure will have a % VOC, when measured according to the modified method described above in this Example, of less than 25%, or less than 10%, or less than 2%.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A set of two different polar seaming agents, comprising:
a polar low-shrink seaming agent that (a) has a viscosity of about 300 centipoise to about 1000 centipoise when measured at any temperature between ambient and 60° C.; and (b) has an immediate welding strength of at least 2 grams that develops within 0.5 seconds when applied to biaxially oriented polypropylene (BOPP), biaxially oriented polyethylene terephthalate (BOPET), or cast polypropylene (CPP); and (c) can obtain a seam quality of at least 2 when applied to BOPP, BOPET, or CPP; and
a polar high-shrink seaming agent that (a) has a Hildebrand solubility parameter that is within 2.2 MPa^{1/2} or within 4.4 calories^{1/2}·cm^{-3/2} of a Hildebrand solubility parameter of polyethylene terephthalate glycol-modified (PETG), polyvinyl chloride (PVC), or polystyrene (PS); and (b) has an immediate welding strength of at least 2 grams that develops within 0.5 seconds when applied to PETG, PVC, or PS; and (c) has a viscosity from at least 1 centipoise to about 300 centipoise when measured at any temperature between ambient and 60° C.; and (d) can obtain a seam quality of at least 2 when applied to PETG, PVC, or PS;
wherein the polar low-shrink seaming agent and the polar high-shrink seaming agent are compatible with each other, and can both be cured within 5 seconds.

2. The set of claim 1, wherein the polar low-shrink seaming agent and the polar high-shrink seaming agent are both soluble in tetrahydrofurfuryl acrylate (THFA) at a ratio (w/w) of 1:10 to 10:1.

3. The set of claim 1, wherein the polar high-shrink seaming agent has an immediate welding strength of at least 2 grams that develops within 0.2 seconds when applied to PETG, PVC, or PS.

4. The set of claim 1, wherein the polar high-shrink seaming agent has an immediate welding strength of at least 2 grams that develops within 0.06 seconds when applied to PETG, PVC, or PS.

5. The set of claim 1, wherein the polar low-shrink seaming agent comprises:
from 0 to about 50 wt % of an acrylate monomer having a molecular weight of 300 daltons (Da) or less;
0 to about 75 wt % of an oligomer or polymer having a viscosity lower than 200,000 centipoise when measured at a temperature between 20° C. and 70° C.;
0 to about 70 wt % of a tackifying agent; and
from about 0.5 wt % to about 15 wt % of a photoinitiator.

6. The set of claim 1, wherein the polar high-shrink seaming agent comprises:
from about 25 wt % to about 98 wt % of a monomer having a molecular weight lower than 300 daltons (Da);
0 to about 70 wt % of an organic solvent;
0 to about 50 wt % of an oligomer or polymer having a molecular weight greater than 300 daltons (Da); and
from about 0.5 wt % to about 15 wt % of a photoinitiator.

7. The set of claim 1, wherein the polar high-shrink seaming agent comprises a monomer having a molecular weight of less than 300 Da that is (a) an acrylic or methacrylic ester, amide, or carbamate having a cyclic ether containing group; or (b) an acrylic or methacrylic ester, amide, or carbamate having an ethoxylated or propoxylated aromatic or cycloaliphatic group; (c) a monoacrylate or diacrylate or triacrylate or polyacrylate or methacrylate of an alkyl diol or polyol; (d) a vinyl lactam; (e) an acrylamide or methacrylamide; (f) vinyl pyrrolidone or a nitrogen heterocyclic unsaturated monomer; (g) a vinyl morpholine; (h) a lactone or lactam having an acrylate, methacrylate, or vinyl group; (i) a phenyl or alkyl phenol acrylate or methacrylate; (j) an ethoxylated or propoxylated phenyl or alkyl phenol acrylate or methacrylate; (k) a mono- or di- or tri-hydroxyl acid acrylate or methacrylate; (l) an urethane acrylate or methacrylate; (m) an allyl ether; (n) a vinyl ester; (o) a mono-, di-, tri-, tetra-, or poly-acrylate or -methacrylate of a polyhydric alcohol, including an ethoxylated or propoxylated polyhydric alcohol; or (p) 2-(2-ethoxyethoxy)ethyl acrylate.

8. The set of claim 1, wherein the polar high-shrink seaming agent comprises a monomer selected from the group consisting of tetrahydrofurfuryl acrylate (THFA) or caprolactone-modified THFA, phenyl acrylate, cyclic trimethylol propane formal acrylate (CTFA), isobornyl acrylate, isobornyl methacrylate, alkoxylated phenyl acrylate, hexanediol diacrylate, butanediol diacrylate, butanediol dimethacrylates, alkoxylated aliphatic or cycloaliphatic diol diacrylate or dimethacrylate, and tricyclodecanedimethanol diacrylate (TCDDA), ethoxylated cyclohexane dimethanol diacrylate (EO-CHMDA), hydroxy pivalic acid neopentyl glycol diacrylate or caprolactone-modified hydroxy pivalic acid neopentyl glycol diacrylate, hydroxypyvalyl pivalate diacrylate (HPPDA), and caprolactone acrylate.

9. The set of claim 1, wherein the polar high-shrink seaming agent comprises an oligomer or polymer selected from the group consisting of urethane acrylate, urethane methacrylate, acrylic or methacrylic esters of glycols or diols or polyhydric alcohols, acrylic or methacrylic esters of alkoxylated diols or polyols or polyhydric alcohols, oligomers of acrylic esters, polyvinylbutyral, hydrocarbon resins, polyterpenes, rosin derivatives, polyesters, epoxy resins, epoxy acrylates, epoxy methacrylates, phenoxy resins, a resin containing a diglycidyl ether of bisphenol-A, polystyrene, styrene block copolymers or terpolymers, terpene phenols, polyester acrylates or methacrylates, polyurethane, polyesteramide, oligomers of acrylic or methacrylic acids or esters or amides; homopolymers, copolymers, terpolymers, or block copolymers of an acrylic acid ester or methacrylic ester; ethoxylated diglycidyl ether of bisphenol A diacrylate; polyacrylates of hyperbranched alcohols; blends of urethane acrylate and monomer; and blends of inert resin and monomer.

10. The set of claim 1, wherein the polar high-shrink seaming agent comprises a solvent selected from the group consisting of ethers, cyclic ethers, esters, amides, glycol ethers, ketones, toluene, halogenated alcohols, and halogenated hydrocarbons.

11. The set of claim 1, wherein the polar high-shrink seaming agent comprises:
from about 25 wt % to about 98 wt % of a monomer;
from 0 wt % to about 75 wt % of an oligomer or polymer;
0 to about 50 wt % of an organic solvent; and
from about 0.5 wt % to about 15 wt % of a photoinitiator.

12. The set of claim 1, wherein the polar high-shrink seaming agent comprises:
from about 15 wt % to about 90 wt % of a monomer;
0 to about 75 wt % of an oligomer or polymer;
0 to about 20 wt % of an organic solvent;
from about 0.5 wt % to about 15 wt % of a photoinitiator; and
0 to about 20 wt % of a tackifying agent.

13. The set of claim 1, wherein the polar high-shrink seaming agent comprises:
from about 10 wt % to about 90 wt % of a monomer;
from 0 wt % to about 80 wt % of an oligomer or polymer;
0 to about 10 wt % of an organic solvent; and
from about 0.5 wt % to about 20 wt % of a photoinitiator.

14. A set of two different non-polar seaming agents, comprising:
a non-polar low-shrink seaming agent that (a) has a viscosity of about 300 centipoise to about 1000 centipoise when measured at any temperature between ambient and 60° C.; and (b) has an immediate welding strength of at least 2 grams that develops within 0.5 seconds when applied to biaxially oriented polypropylene (BOPP), biaxially oriented polyethylene terephthalate (BOPET), or cast polypropylene (CPP); and (c) can obtain a seam quality of at least 2 when applied to BOPP, BOPET, or CPP; and
a non-polar high-shrink seaming agent that (a) has a Hildebrand solubility parameter that is within 2.2 MPa^{1/2} or within 4.4 calories^{1/2}·cm^{-3/2} of a Hildebrand solubility parameter of a polyolefin or a cyclic olefin polymer (COP) or a cyclic olefin copolymer (COC); and (b) has an immediate welding strength of at least 2 grams that develops within 0.5 seconds when applied to a polyolefin or COP or COC; and (c) has a viscosity from at least 1 centipoise to about 300 centipoise when measured at any temperature between ambient and 60° C.; and (d) can obtain a seam quality of at least 2 when applied to a polyolefin or COP or COC;
wherein the non-polar low-shrink seaming agent and the non-polar high-shrink seaming agent are compatible with each other, and can both be cured within 5 seconds.

15. The set of claim 14, wherein the non-polar low-shrink seaming agent and the non-polar high-shrink seaming agent are both soluble in isobornyl acrylate (IBOA) at a ratio (w/w) of 1:10 to 10:1.

16. The set of claim 14, wherein the non-polar low-shrink seaming agent comprises:
from 0 to about 50 wt % of an acrylate monomer having a molecular weight of 300 daltons (Da) or less;
0 to about 75 wt % of an oligomer or polymer having a viscosity lower than 200,000 centipoise when measured at a temperature between 20° C. and 70° C.;
0 to about 70 wt % of a tackifying agent; and
from about 0.5 wt % to about 15 wt % of a photoinitiator.

17. The set of claim 14, wherein the non-polar high-shrink seaming agent comprises:
from about 25 wt % to about 98 wt % of a monomer having a molecular weight lower than 300 daltons (Da);
0 to about 70 wt % of an organic solvent;
0 to about 50 wt % of an oligomer or polymer having a molecular weight greater than 300 daltons (Da); and
from about 0.5 wt % to about 15 wt % of a photoinitiator.

18. The set of claim 14, wherein the non-polar high-shrink seaming agent comprises an acrylic or methacrylic acid ester or amide or carbamate containing a cyclic hydrocarbon group; an acrylic or methacrylic acid ester or amide or carbamate containing a hydrocarbon having a maximum of 20 carbon atoms; or an acrylic or methacrylic acid ester or amide or carbamate containing an aromatic hydrocarbon or heterocyclic group having a maximum of 20 carbon atoms.

19. The set of claim 14, wherein the non-polar high-shrink seaming agent comprises a monomer having a molecular weight of less than 300 Da selected from the group consisting of isobornyl acrylate, isobornyl methacrylate, cyclohexyl acrylate, ethyl hexyl acrylate, ethyl hexyl methacrylate, tert-butyl cyclohexyl acrylate, trimethyl cyclohexyl acrylate, alkyl acrylates, alkyl methacrylates, tricyclodecanedimethanol acrylate, styrene, vinyltoluene, benzyl acrylate, lauryl acrylate, isodecyl acrylate, phenoxy benzyl acrylate, ethoxylated aryl acrylate, alkylated phenyl acrylate, and phenyl acrylate.

20. The set of claim 14, wherein the non-polar high-shrink seaming agent comprises an oligomer or polymer having a molecular weight of more than 300 Da selected from the group consisting of urethane acrylate, urethane methacrylate, acrylic or methacrylic esters of glycols or diols or polyhydric alcohols, acrylic or methacrylic esters of alkoxylated diols or polyols or polyhydric alcohols, oligomers of acrylic or methacrylic esters, polyvinylbutyral, hydrocarbon resins, polyterpenes, rosin derivatives, polyesters, polystyrene, styrene block copolymers, epoxy acrylates, epoxy methacrylates, phenoxy resins, acrylated or methacrylated dendritic alcohols, ethoxylated diglycidyl ether of bisphenol A diacrylate; polyacrylates of hyperbranched alcohols; blends of urethane acrylate and monomer; and blends of inert resin and monomer.

21. The set of claim 14, wherein the non-polar high-shrink seaming agent comprises a solvent selected from the group consisting of a linear or cyclic or aromatic hydrocarbon having a maximum of 20 carbon atoms, a terpene alcohol, an alkyl ester, an alkyl amide, turpentines, isoparaffins, and paraffins.

22. The set of claim 14, wherein the non-polar high-shrink seaming agent comprises:
from about 25 wt % to about 98 wt % of a monomer;
from 0 wt % to about 50 wt % of an oligomer or polymer;
0 to about 50 wt % of an organic solvent; and
from about 0.5 wt % to about 15 wt % of a photoinitiator.

23. The set of claim 14, wherein the non-polar high-shrink seaming agent comprises:
from about 20 wt % to about 98 wt % of a monomer;
0 to about 45 wt % of an oligomer or polymer;
0 to about 30 wt % of an organic solvent;
from about 1 wt % to about 15 wt % of a photoinitiator; and
0 to about 20 wt % of a tackifying agent.

24. The set of claim 14, wherein the non-polar high-shrink seaming agent comprises:
from about 20 wt % to about 98 wt % of a monomer;
from 0 wt % to about 45 wt % of an oligomer or polymer;
0 to about 25 wt % of an organic solvent;
from about 1 wt % to about 15 wt % of a photoinitiator; and
0 to about 20 wt % of a tackifying agent.

25. A pump-and-meter system for use with the set of two different seaming agents according to claim 1, wherein either:
(a) the low-shrink seaming agent can be applied with the system after removing the high-shrink seaming agent from the system without flushing in between; or
(b) the high-shrink seaming agent can be applied with the system after removing the low-shrink seaming agent from the system without flushing in between.

26. A method for applying a first label to a first article and a second label to a second article using a single pump-and-meter system, comprising:
bonding a leading edge of the first label to the first article;
using the single pump-and-meter system to apply a first seaming agent to the leading edge or the trailing edge of the first label, the single pump-and-meter system being connected to a first seaming agent source;
wrapping the first label around the first article to form a seam that joins the trailing edge of the first label to the leading edge of the first label with the first seaming agent;
exposing the seam of the first label to radiation;
disconnecting the single pump-and-meter system from the first seaming agent source;
connecting the single pump-and-meter system to a second seaming agent source that contains a second seaming agent which is different from the first seaming agent;
bonding a leading edge of the second label to the second article;
using the single pump-and-meter system to apply the second seaming agent to the leading edge or the trailing edge of the second label;
wrapping the second label around the second article to form a seam that joins the trailing edge of the second label to the leading edge of the second label with the second seaming agent; and
exposing the seam of the second label to radiation;
wherein the seam of the first label and the seam of the second label each have an immediate welding strength of at least 2 grams when measured with a seam area of 250 mm² prior to exposing the seam to radiation; and
wherein the first seaming agent and the second seaming agent are soluble in each other at a ratio (w/w) of 1:10 to 10:1; and
wherein the first seaming agent and the second seaming agent are both polar or are both non-polar; and
wherein the first seaming agent and the second seaming agent each have a viscosity of about 1000 centipoise or less when measured at any temperature between ambient temperature and 60° C.

27. The method of claim 26, wherein the seam of the first label or the seam of the second label is exposed to radiation for a time period of about 0.05 seconds to about 5 seconds.

28. The method of claim 26, wherein either (A) the first label is a low-shrink label and the second label is a high shrink wrap label; or (B) the first label is a high shrink wrap label and the second label is a low-shrink label.

29. The method of claim 26, wherein the pump-and-meter system is not flushed between disconnecting the first seaming agent source and connecting the single pump-and-meter system to the second seaming agent source.

30. The method of claim 26, wherein the pump-and-meter system includes a pump, a nozzle, a port for a fluid source, and a fluid passageway between the nozzle and the port for the fluid source.
